(19) United States
(12) Patent Application Publication
(10) Pub. No.: US 2026/0230386 A1
(43) Pub. Date: Aug. 6, 2026

(54) METHOD AND APPARATUS FOR LARGE-SCALE SECTOR CARRIER ASSIGNMENT

(71) Applicant: Telefonaktiebolaget LM Ericsson (publ), Stockholm (SE)

(72) Inventors: Róbert SZABÓ, Budapest (HU); Carla MOURADIAN, Montreal (CA); Ákos RECSE, Halasztelek (HU); Wubin LI, Kirkland (CA)

(73) Assignee: Telefonaktiebolaget LM Ericsson (publ), Stockholm (SE)

(21) Appl. No.: 19/152,452

(22) PCT Filed: Feb. 14, 2023
(86) PCT No.: PCT/IB2023/051338

§ 371 Date: Jul. 31, 2025

(51) Int. Cl. H04L 41/0896; H04L 41/0894; H04L 41/0895; H04L 41/122

(52) U.S. Cl. CPC H04L 41/0896; H04L 41/0894; H04L 41/0895; H04L 41/122

(57) ABSTRACT

A method and associated electronic device are disclosed for assigning computing resources, provided by a plurality of electronic devices of a mobile network, to support a plurality of sector carriers of the mobile network. The method comprises acquiring information describing the plurality of sector carriers that includes one or both of an affinity constraint and an anti-affinity constraint between different sector carriers of pairs of the plurality of sector carriers. The method further comprises constructing, using the information describing the plurality of sector carriers, a distance matrix having values representing distances between different sector carriers of the plurality of sector carriers. The method further comprises applying, using the distance matrix and information describing the computing resources, an iterative hierarchical clustering algorithm to the plurality of sector carriers to assign the plurality of sector carriers among the plurality of electronic devices.

### TECHNICAL FIELD

Embodiments of the invention relate to the field of mobile networks; and more specifically, to techniques for assigning computing resources to support sector carriers in a mobile network.

### BACKGROUND ART

Cellular telecommunication networks, sometimes referred to herein as “mobile networks,” are relatively large networks encompassing a large number of electronic devices to enable other electronic devices (sometimes referred to as “user equipment” (UE) or “mobile devices”) to connect wirelessly to the mobile network. The mobile network is also typically connected to one or more other networks (e.g., the Internet). The mobile network enables the electronic devices currently connected to the mobile network to communicate over the network(s) with other electronic devices. The mobile network is designed to allow the mobile devices, e.g., mobile phones, tablets, laptops, IoT devices and similar devices, to shift connection points with the mobile network in a manner that maintains continuous connections for the applications of the mobile devices. Typically, the mobile devices connect to the mobile network via radio access network (RAN) base stations (sometimes referred to as “access points”), which provide connectivity to a number of mobile devices for a local area or “cell”. Managing and configuring the mobile network including the cells of the mobile network is an administrative challenge as each cell can have different geographic and/or technological characteristics.

In modern implementations of mobile networks, such as 5G, 6G, or beyond, a number of different resources such as radio resources and computing resources (e.g., compute, storage, transport) are provisioned to provide connections and services to a number of mobile devices. Achieving suitable performance of the mobile network, such as service availability and service assurance, may require the real-time prioritization of the different provisioned resources. The prioritization may be challenging, as a finite amount of resources are balanced with a number of competing (and sometimes contradicting) objectives while still meeting resiliency, mobility, and/or energy efficiency requirements of the mobile network. For example, in a cloud-based RAN, resources are provisioned for virtualized distributed units (DUs), centralized units providing user plane functionality (CU-UP), centralized units providing control plane functionality (CU-CP), and the routing of enhanced Common Public Radio Interface (eCPRI) traffic to the virtualized DUs in Hub sites. The cloud-based RAN may have contradicting objectives, such as a high mobility requirement that incentivizes hosting multiple virtualized DU instances on a single server, and a resiliency requirement that incentivizes hosting the multiple virtualized DU instances on different servers.

### SUMMARY

In one embodiment, a method is performed by an electronic device for assigning computing resources, provided by a plurality of electronic devices of a mobile network, to support a plurality of sector carriers of the mobile network. The method comprises acquiring information describing the plurality of sector carriers that includes one or both of an affinity constraint and an anti-affinity constraint between different sector carriers of pairs of the plurality of sector carriers. The method further comprises constructing, using the information describing the plurality of sector carriers, a distance matrix having values representing distances between different sector carriers of the plurality of sector carriers. The method further comprises applying, using the distance matrix and information describing the computing resources, an iterative hierarchical clustering algorithm to the plurality of sector carriers to assign the plurality of sector carriers among the plurality of electronic devices.

In another embodiment, an electronic device comprises a machine-readable medium comprising computer program code, and one or more processors to execute the computer program code to perform operations for assigning computing resources, provided by a plurality of electronic devices of a mobile network, to support a plurality of sector carriers of the mobile network. The operations comprise acquiring information describing the plurality of sector carriers that includes one or both of an affinity constraint and an anti-affinity constraint between different sector carriers of pairs of the plurality of sector carriers. The operations further comprise constructing, using the information describing the plurality of sector carriers, a distance matrix having values representing distances between different sector carriers of the plurality of sector carriers. The operations further comprise applying, using the distance matrix and information describing the computing resources, an iterative hierarchical clustering algorithm to the plurality of sector carriers to assign the plurality of sector carriers among the plurality of electronic devices.

### BRIEF DESCRIPTION OF THE DRAWINGS

The invention may best be understood by referring to the following description and accompanying drawings that are used to illustrate embodiments of the invention. In the drawings:

FIG. 1 illustrates a method performed by an electronic device for assigning computing resources, provided by a plurality of electronic devices of a mobile network, to support a plurality of sector carriers of the mobile network, according to one or more embodiments.

FIG. 2 illustrates a method of iterative hierarchical clustering of a plurality of sector carriers, according to one or more embodiments.

FIG. 3 illustrates an exemplary mobile network, according to one or more embodiments.

FIG. 4 illustrates an exemplary hierarchy of computing resources including virtualized resources at one or more levels of virtualization, according to one or more embodiments.

FIG. 5A illustrates an exemplary assignment of computing resources to support a plurality of sector carriers of a mobile network, according to one or more embodiments.

FIG. 5B illustrates an exemplary assignment of computing resources to support a plurality of sector carriers of a mobile network, according to one or more embodiments.

FIG. 6A illustrates connectivity between network devices (NDs) within an exemplary network, as well as three exemplary implementations of the NDs, according to one or more embodiments.

FIG. 6B illustrates an exemplary way to implement a special-purpose network device according to one or more embodiments.

FIG. 6C illustrates various exemplary ways in which virtual network elements (VNEs) may be coupled according to one or more embodiments.

FIG. 6D illustrates a network with a single network element (NE) on each of the NDs, and within this straightforward approach contrasts a traditional distributed approach (commonly used by traditional routers) with a centralized approach for maintaining reachability and forwarding information (also called network control), according to one or more embodiments.

FIG. 6E illustrates the simple case of where each of the NDs implements a single NE, but a centralized control plane has abstracted multiple of the NEs in different NDs into (to represent) a single NE in one of the virtual network(s), according to one or more embodiments.

FIG. 6F illustrates a case where multiple VNEs are implemented on different NDs and are coupled to each other, and where a centralized control plane has abstracted these multiple VNEs such that they appear as a single VNE within one of the virtual networks, according to one or more embodiments.

FIG. 7 illustrates a general purpose control plane device with centralized control plane (CCP) software, according to one or more embodiments.

### DETAILED DESCRIPTION

The following description describes methods and apparatus for assigning computing resources, provided by one or more electronic devices of a mobile network, to support a plurality of sector carriers of the mobile network. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

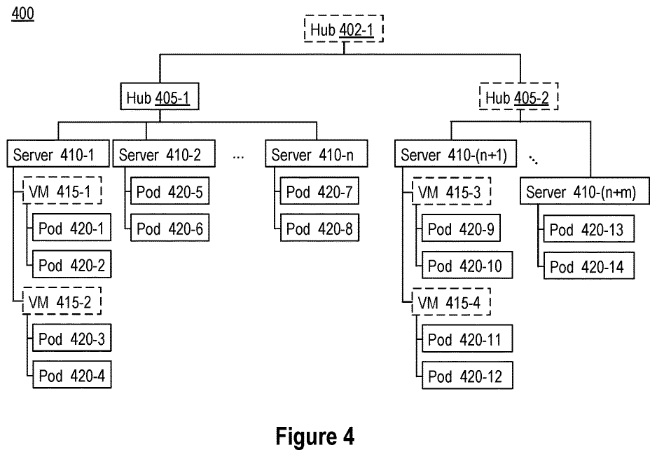

In various embodiments described herein, the sector carrier assignment problem may be modeled as an offline optimization problem. More specifically, the assignment of multiple levels of computing resources (e.g., including virtualized resources at one or more levels of virtualization) may be modeled as a hierarchical bin packing problem, as illustrated in FIG. 4 and discussed in greater detail below. In an exemplary hierarchical bin packing problem, sector carriers of the mobile network are assigned to virtualized (software-based) DUs, and the virtualized DUs are assigned to containers (one example of virtualization units) of physical servers (one example of physical computing units). The hierarchical bin packing problem is non-trivial at large scale, for example, supporting numerous sector carriers in mobile networks encompassing tens, hundreds, or thousands of electronic devices, and so forth.

In various embodiments described herein, a method and associated electronic device are described for assigning computing resources, provided by a plurality of electronic devices of a mobile network, to support a plurality of sector carriers of the mobile network. The method comprises acquiring information describing the plurality of sector carriers that includes one or both of an affinity constraint and an anti-affinity constraint between different sector carriers of pairs of the plurality of sector carriers. The method further comprises constructing, using the information describing the plurality of sector carriers, a distance matrix having values representing distances between different sector carriers of the plurality of sector carriers. The method further comprises applying, using the distance matrix and information describing the computing resources, an iterative hierarchical clustering algorithm to the plurality of sector carriers to assign the plurality of sector carriers among the plurality of electronic devices.

Thus, the multiple level sector carrier requirements are modeled in the distance matrix in a pairwise fashion, using the affinity constraint (e.g., mobility requirement) and the anti-affinity constraint (e.g., resiliency requirement). The distance values of the distance matrix represent how strongly the competing requirements “attract” or “repel” the sector carriers. The mobility requirements incentivize sector carriers to be nearer to each other, and therefore have a smaller distance assigned between the sector carriers. The resiliency requirements incentivize sector carriers to be further from each other, and therefore have a greater distance assigned.

Beneficially, the construction of the distance matrix allows an optimized server assignment configuration to be determined for any known demand set, e.g., resource requirements as well as service requirements such as resiliency and mobility. Preferences regarding prioritization of the service requirements may be flexibly encoded within the distance matrix calculations.

In some embodiments, applying the iterative hierarchical clustering algorithm is used to solve a first stage of assigning the plurality of sector carriers, considering the capacity limits of the plurality of electronic devices (e.g., servers). A second stage of the assigning the plurality of sector carriers may be performed to assign sector carriers to the various virtualization units of the plurality of electronic devices.

In some embodiments, the results of applying the iterative hierarchical clustering algorithm are used to determine a minimum number of required clusters (e.g., servers) to support the plurality of sector carriers. Through the iterative process, a number of clusters can be determined that corresponds to a minimal number of requirements violations while maintaining high resource utilization.

Beneficially, use of the iterative process permits resource capacity limits, connection limits, or a flexible combination thereof to be considered, both at the level of physical resources (e.g., servers) and virtualized resources (e.g., pods).

Overall, the techniques described herein reduce costs, as well as energy consumption, of the mobile network while supporting the plurality of sector carriers. For example, the techniques allow the plurality of sector carriers to be supported using a reduced number of computing devices through maximizing utilization of the physical resources. Further, in some embodiments, a two-stage approach is used to first solve the assignment to the electronic devices, then solve the assignment to the virtualization units provided using the electronic devices. Beneficially, the two-stage approach reduces the number of optimization variables to be solved by a factor of the number of possible virtualization units per electronic device, which typically provides an order of magnitude in complexity gain. In this way, the two-stage approach may reduce the computing resources (e.g., CPU cycles, memory) that are required to perform the optimization, and may be completed more quickly.

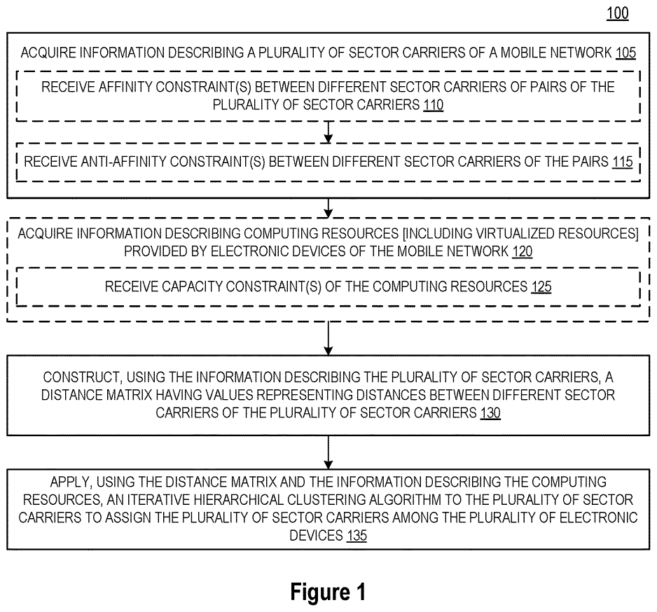

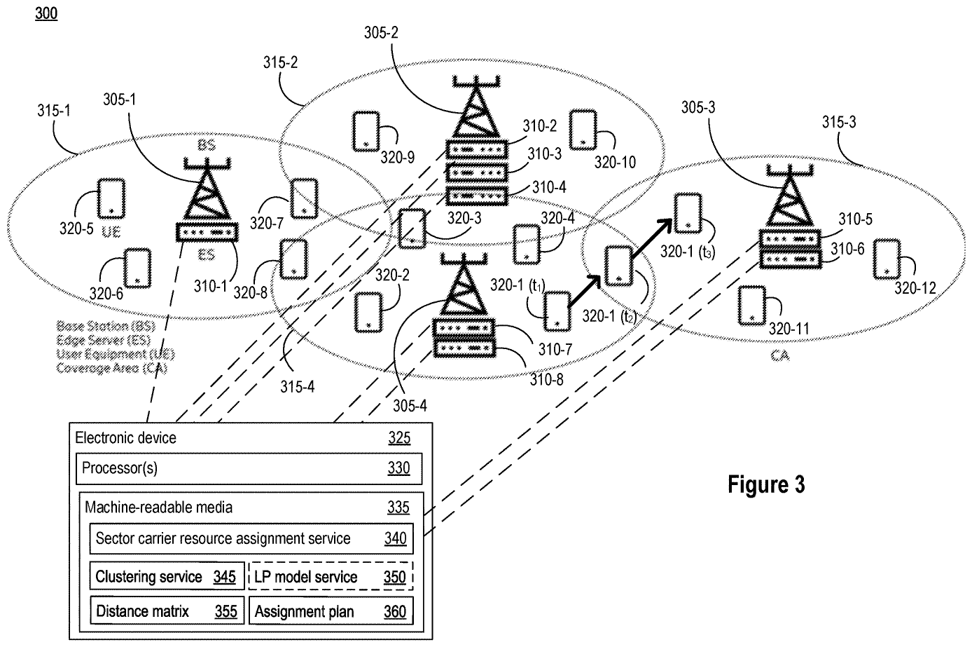

FIG. 1 illustrates a method 100 performed by an electronic device for assigning computing resources, provided by a plurality of electronic devices of a mobile network, to support a plurality of sector carriers of the mobile network, according to one or more embodiments. For example, the method 100 may be performed using the electronic device 325 of FIG. 3, but other types or configurations of electronic devices are also contemplated.

As used herein, an electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, solid state drives, read only memory (ROM), flash memory devices, phase change memory) and machine-readable transmission media (also called a carrier) (e.g., electrical, optical, radio, acoustical or other form of propagated signals-such as carrier waves, infrared signals). Thus, an electronic device (e.g., a computer) includes hardware and software, such as a set of one or more processors (e.g., wherein a processor is a microprocessor, controller, microcontroller, central processing unit, digital signal processor, application specific integrated circuit, field programmable gate array, other electronic circuitry, a combination of one or more of the preceding) coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interface(s) (NI(s)) to establish network connections (to transmit and/or receive code and/or data using propagating signals) with other electronic devices. For example, the set of physical NIs (or the set of physical NI(s) in combination with the set of processors executing code) may perform any formatting, coding, or translating to allow the electronic device to send and receive data whether over a wired and/or a wireless connection. In some embodiments, a physical NI may comprise radio circuitry capable of receiving data from other electronic devices over a wireless connection and/or sending data out to other devices via a wireless connection. This radio circuitry may include transmitter(s), receiver(s), and/or transceiver(s) suitable for radiofrequency communication. The radio circuitry may convert digital data into a radio signal having the appropriate parameters (e.g., frequency, timing, channel, bandwidth, etc.). The radio signal may then be transmitted via antennas to the appropriate recipient(s). In some embodiments, the set of physical NI(s) may comprise network interface controller(s) (NICs), also known as a network interface card, network adapter, or local area network (LAN) adapter. The NIC(s) may facilitate in connecting the electronic device to other electronic devices allowing them to communicate via wire through plugging in a cable to a physical port connected to a NIC. One or more parts of an embodiment of the invention may be implemented using different combinations of software, firmware, and/or hardware.

The method 100 will be described with reference to the mobile network 300 of FIG. 3, which illustrates the electronic device 325 including a sector carrier resource assignment service 340, a clustering service 345, and an optional linear programing (LP) model service 350. The mobile network 300 is depicted in a simplified form for the sake of illustration. The person of ordinary skill in the art will appreciate that the mobile network 300 may include numerous additional electronic devices, functions, and components that would be involved in the operation of the mobile network 300. The mobile network 300 can implement any communication technology, whether proprietary or standardized, such as 3G, 4G, 5G (e.g., as defined by 3GPP) technologies or similar technologies.

The mobile network 300 comprises a plurality of edge servers 310-1, 310-2, . . . , 310-8 (generically or collectively, edge server(s) 310). Each of the edge servers 310-1, 310-2, . . . , 310-8 may be implemented using any type or combination of electronic device(s) that provide computing resources at, or in combination with, access points to the mobile network 300 such as a respective RAN base station 305-1, 305-2, 305-3, 305-4 (also referred to as “base stations”) of the mobile network 300. The edge servers 310-1, 310-2, . . . , 310-8, the base stations 305-1, 305-2, 305-3, 305-4, and/or other electronic devices, functions, and components of the RAN can enable wireless connections with a number of mobile devices 320-1, 320-2, . . . , 320-12 (generically or collectively, mobile device(s) 320) that use the services of the mobile network 300.

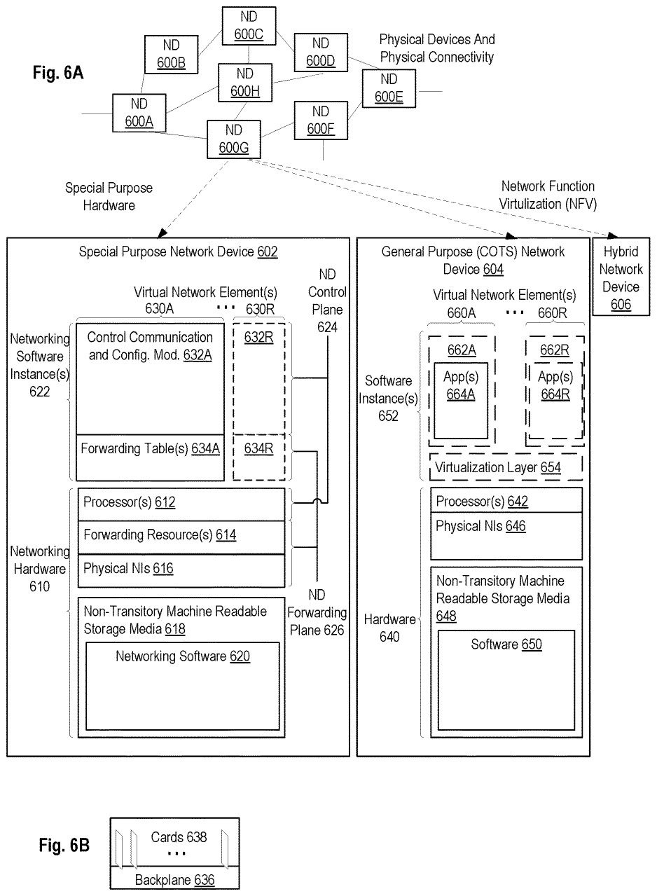

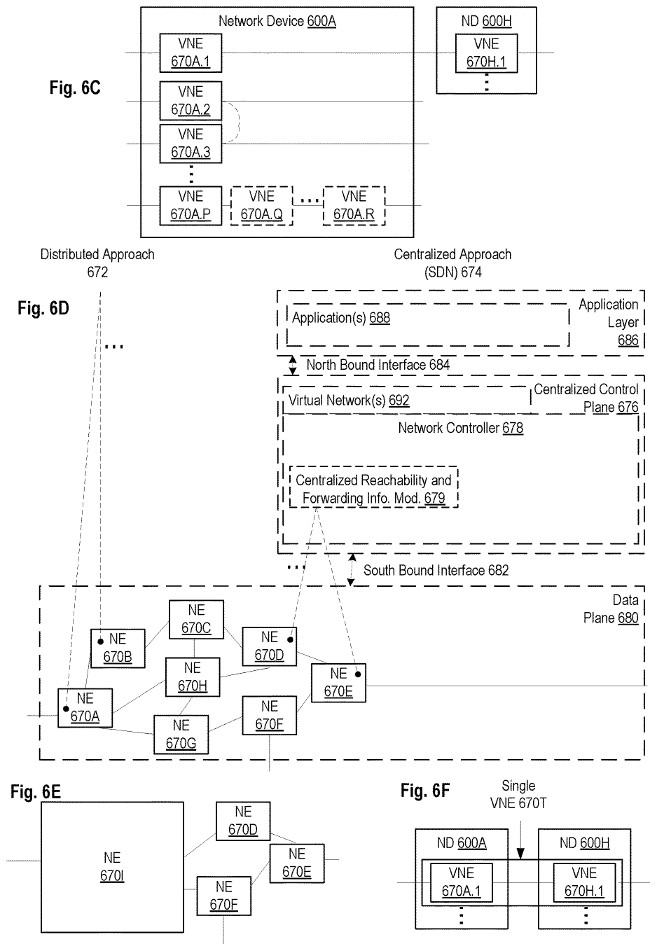

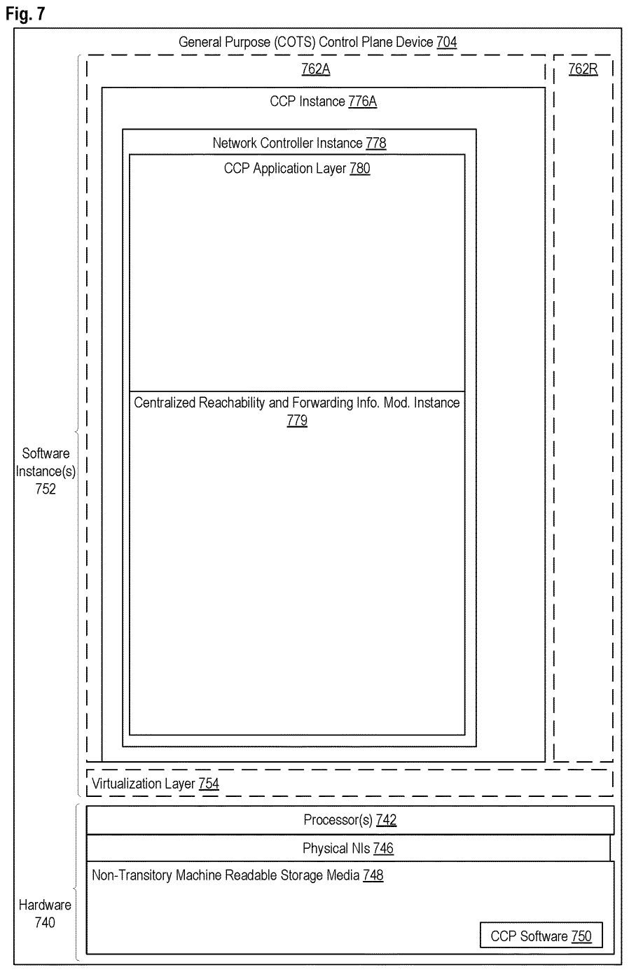

The edge servers 310-1, . . . , 310-8 are implemented using one or more electronic devices of the mobile network 300. In some embodiments, the electronic device(s) are implemented as dedicated edge server(s) 310. In some embodiments, the electronic device(s) provide the edge server(s) 310 as services (e.g., implemented as virtual network elements). Additional implementation details are discussed below with respect to FIGS. 6A-6F and 7. As shown in the mobile network 300, the edge server 310-1 is connected to the base station 305-1 having a coverage area 315-1. The edge servers 310-2, 310-3, 310-4 are connected to the base station 305-2 having a coverage area 315-2. The edge servers 310-5, 310-6 are connected to the base station 305-3 having a coverage area 315-3. The edge servers 310-7, 310-8 are connected to the base station 305-4 having a coverage area 315-4. Based on the relative locations and the operational characteristics of the base stations 305-1, 305-2, 305-3, 305-4, the coverage areas 315-1, 315-2, 315-3, 315-4 (generically or collectively, coverage area(s) 315) are arranged to have some overlap with each other.

The mobile devices 320 as shown are distributed within the coverage areas 315-1, 315-2, 315-3, 315-4. As the mobile devices 320 are mobile in nature, the mobile devices 320 are expected to transit various ones of the coverage areas 315-1, 315-2, 315-3, 315-4. Further, the mobile devices 320 at times may be within coverage area(s) 315 associated with multiple ones of the edge servers 310-1, . . . , 310-8 at a given time (e.g., within a single coverage area 315-1, 315-2, . . . , 315-4 that is associated with multiple edge servers 310-1, . . . , 310-8, or located in an overlapping region of the coverage areas 315-1, 315-2, 315-3, 315-4). For example, a first mobile device 320-1 at a first time t₁ is within the coverage area 315-4, and travels such that the first mobile device 320-1 is in overlapping coverage areas 315-3, 315-4 at a second time t₂, and in the coverage area 315-3 at a third time t₃.

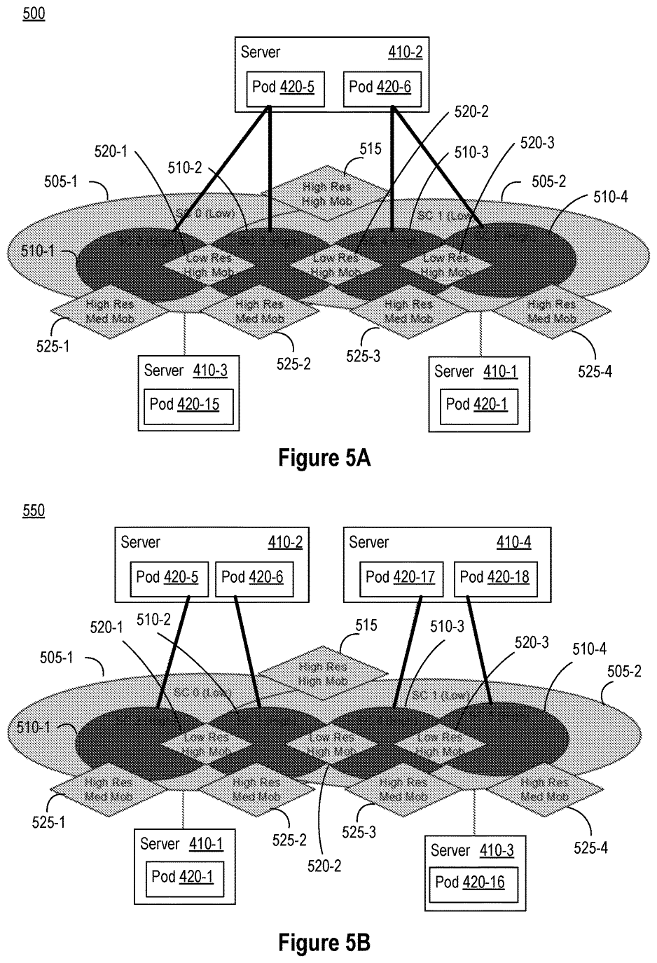

Within the coverage areas 315-1, 315-2, 315-3, 315-4, each of the RAN base stations 305-1, 305-2, 305-3, 305-4 operates to provide a respective one or more sector carriers corresponding to one or more spectrum bands. For example, assuming that the mobile network 300 is a 5G network, the RAN base stations 305 may be operated to provide sector carriers corresponding to one or more “low” bands (e.g., frequencies less than 1 gigahertz (GHz)), one or more “mid” bands (e.g., frequencies between 1-2.6 GHz and/or 3.5-6 GHZ), and/or one or more “high” bands (frequencies between 24-40 GHz). The configuration of the RAN base stations 305 (e.g., specifying the number and/or spectrum bands of the sector carriers) may be determined to provide a desired service availability and/or performance for the mobile device(s) 320. Some examples of the sector carriers are illustrated in FIGS. 5A and 5B and discussed in greater detail below. The person of ordinary skill will understand the RAN base stations 305 may provide any other suitable numbers of sector carriers, which may correspond to any different spectrum bands.

As previously described, while electronic devices may include a number of components, FIG. 3 shows the electronic device 325 as comprising one or more processors 330 and machine-readable media 335 for simplicity. While depicted as a single element within the electronic device 325, and consistent with the discussion of an electronic device above, the one or more processors 330 contemplates a single processor, multiple processors, a processor or processors having multiple cores, as well as combinations thereof. In one embodiment, the one or more processors 330 comprises a host central processing unit (CPU) of the electronic device 325.

Consistent with the discussion of an electronic device above, the machine-readable media, such as machine-readable media 335, may include a variety of media selected for relative performance or other capabilities: volatile and/or non-volatile media, removable and/or non-removable media, etc. Thus, the machine-readable media 335 may include cache, random access memory (RAM), storage, etc. Storage included in the machine-readable media 335 typically provides a non-volatile memory for the electronic device 325, and may include one or more different storage elements such as Flash memory, a hard disk drive, a solid state drive, an optical storage device, and/or a magnetic storage device. In some embodiments, the machine-readable media 335 stores the sector carrier resource assignment service 340, the clustering service 345, and the optional LP model service 350, each representing code that is executed by the one or more processors 330 to implement various functionality described herein.

As discussed above, the assignment of multiple levels of computing resources (e.g., including virtualized resources at one or more levels of virtualization) may be modeled as a hierarchical bin packing problem, where sector carriers of the mobile network 300 are assigned physical resources and/or virtual resources provided by electronic device(s) (e.g., various ones of the edge servers 310) of the mobile network 300. In some embodiments, each request for a sector carrier is assigned to a selected edge server 310 of the plurality of edge servers 310 of the mobile network 300, as well as a software instance (e.g., a container or a pod) running on the selected edge server 310, which can host multiple software instances.

The optional LP model service 350 constructs a LP model based on acquired information describing the plurality of sector carriers, an affinity constraint between different sector carriers of pairs of the plurality of sector carriers, and an anti-affinity constraint between the different sector carriers of the pairs of the plurality of sector carriers. The LP model includes one or more penalty terms corresponding to one or both of the affinity constraint and the anti-affinity constraint.

The sector carrier resource assignment service 340 determines whether an optimal solution exists for the LP model. The sector carrier resource assignment service 340 generates an assignment plan 360 corresponding to the optimal solution (when the optimal solution is determined to exist). In some embodiments, when the optimal solution is determined not to exist, the sector carrier resource assignment service 340 generates an adjustment report that includes one or more adjustments to one or more of: the affinity constraint, the anti-affinity constraint, and the capacity constraint that would permit an optimal solution to exist. In some embodiments, the sector carrier resource assignment service 340 also communicates the assignment plan 360 to a deployment service (not shown) to deploy the assignment plan 360 and thereby configure the electronic device(s) (e.g., the edge servers 310) of the mobile network 300 to support the set of sector carriers.

Returning to FIG. 1, the method 100 begins at block 105, where the electronic device 325 (e.g., the sector carrier resource assignment service 340) acquires information describing a plurality of sector carriers of the mobile network 300. The information describing the plurality of sector carriers may be provided in any suitable form. For example, the information may be provided to the electronic device 325 as a sector carrier assignment request.

In some embodiments, acquiring information describing the plurality of sector carriers comprises, at optional block 110, receiving one or more affinity constraints between different sector carriers of pairs of the plurality of sector carriers. In some embodiments, acquiring information describing the plurality of sector carriers comprises, at optional block 115, receiving one or more anti-affinity constraints between different sector carriers of pairs of the plurality of sector carriers.

In the examples discussed herein, the affinity constraint represents a mobility requirement between different sector carriers, and the anti-affinity constraint represents a resiliency requirement between different sector carriers. However, the affinity constraint and the anti-affinity constraint are contemplated as representing one or more other requirements, which may be alternate to, or in combination with, the mobility requirement and/or the resiliency requirement. For example, the affinity constraint may (also) represent an energy efficiency requirement, the anti-affinity constraint may (also) represent a load-spreading requirement, and so forth.

In some embodiments, the affinity constraint and/or the anti-affinity constraint may be modeled as “hard” constraints (that is, required to be satisfied at all times) and/or as “soft” constraints (that is, should be satisfied as much as possible). If the soft constraint(s) are not satisfied, one or more penalty terms are added to an objective function (e.g., included in a LP model provided by the LP model service 350, described below).

The affinity constraint and/or anti-affinity constraint may be provided in any suitable form. In one example, the affinity constraint and/or anti-affinity constraint correspond to one or more discrete levels of requirements (e.g., low, medium, and high mobility, low, medium, and high resiliency) between the different sector carriers. The values of the affinity constraint and/or anti-affinity constraint may be selected based on different types of sector carriers (e.g., a same value is applied for pairs of sector carriers having a same type or pair of types) or specific to each pairing of the sector carriers (e.g., each distinct pair of sector carriers may be given a different value).

The method 100 proceeds to optional block 120, where the electronic device 325 (e.g., the sector carrier resource assignment service 340) acquires information describing the computing resources provided by the electronic devices of the mobile network 300. In some embodiments, the computing resources include physical resources provided by the one or more electronic devices, as well as virtualized resources provided at one or more levels of virtualization. In one non-limiting example, the physical resources may include (1) a plurality of hubs, and (2) a plurality of servers, where each hub is connected with one or more of the servers; and the virtualized resources may include (1) a plurality of virtual machines (VMs) hosted on various ones of the servers, and (2) a plurality of pods (or containers) implemented on particular servers and/or particular VMs.

The information describing the computing resources provided by the electronic devices may also be provided in any suitable form, and may be received with any timing relative to receiving the information describing the plurality of sector carriers. In one example, the information describing the computing resources may be acquired responsive to receiving a sector carrier assignment request. In another example, the information describing the computing resources may be acquired prior to receiving the sector carrier assignment request. In yet another example, the information describing the computing resources may be acquired partly or fully overlapping in time with receiving the sector carrier assignment request.

In some embodiments, acquiring the information describing the computing resources comprises, at optional block 125, receiving one or more capacity constraints of the computing resources. In one non-limiting example of the capacity constraints, each server has a maximum capacity of two (2) pods, and each pod has a maximum capacity of two (2) sector carriers (such that each server may support up to four (4) carriers). Other values of the capacity constraints are also contemplated.

Refer now to diagram 400 of FIG. 4, which illustrates an exemplary hierarchy of computing resources including virtualized resources at one or more levels of virtualization, according to one or more embodiments. The features shown in the diagram 400 may be used in conjunction with other embodiments, e.g., representing the computing resources provided by one possible implementation of the mobile network 300 of FIG. 3.

In the diagram 400, the hierarchy includes a hub 405-1, a plurality of n servers 410-1, 410-2, . . . , 410-n that are each connected with the hub 405-1, and a plurality of pods 420-1, 420-2, . . . , 420-8 implemented using various ones of the plurality of servers 410-1, 410-2, . . . , 410-n.

In some embodiments, the hierarchy further includes another hub 405-2 that is arranged at a same level at the hub 405-1, and a second plurality of m servers 410-(n+1), . . . , 410-(n+m) that are each connected with the hub 405-2, and a second plurality of pods 420-9, . . . , 420-14 implemented on various ones of the second plurality of servers 410-(n+1), . . . , 410-(n+m). The hierarchy further includes a hub 402-1 that is arranged at a higher level than the hubs 405-1, 405-2 and that connects to the hubs 405-1, 405-2. In some cases, the hub 402-1 may provide a supervisory functionality to the hubs 405-1, 405-2 (e.g., coordinating and/or controlling operation).

In some embodiments, the hierarchy further includes a plurality of VMs 415-1, . . . , 415-4 that are hosted on the respective servers 410-1, 410-(n+1). In such embodiments, some or all of the plurality of pods 420-1, 420-2, . . . , 420-8 and the second plurality of pods 420-9, . . . , 420-14 are implemented on the VMs 415-1, . . . , 415-4. In this way, the virtualized resources provided by the electronic devices of the mobile network may be provided at multiple levels of virtualization (with the VMs 415-1, . . . , 415-4 representing a first level, and the pods 420-1, . . . , 420-14 that are implemented on the VMs 415-1, . . . , 415-4 representing a second level). In alternate embodiments, all of the pods 420-1, . . . , 420-14 are implemented directly on the respective servers 410-1, . . . , 410-(n+m) (that is, without an intermediate virtualization level). Such a hierarchy may be represented using different forms of variables in the LP model. For example, the LP model may include X[i, j, k]=1 to indicate that a sector carrier k is hosted in a VM j which is on a server i, and may also include Y[i, j]=1 to indicate that a sector carrier j is directly hosted on a server i.

Next, FIG. 5A illustrates an exemplary assignment of computing resources to support a plurality of sector carriers of a mobile network, according to one or more embodiments. The features in diagram 500 may be used in conjunction with other embodiments, for example, using the hierarchy of computing resources shown in FIG. 4.

As discussed above, the mobile network 300 may support a plurality of sector carriers, at least some of which provide overlapping coverage with each other to enable mobile devices to maintain a continuous connection to the mobile network 300 as the mobile device traverses the mobile network 300. In some embodiments, the plurality of sector carriers comprises one or more first sector carriers 510-1, . . . , 510-4 corresponding to a first spectrum band, and one or more second sector carriers 505-1, 505-2 corresponding to a second spectrum band. Six (6) sector carriers are shown in the diagram 500: two (2) SCs 505-1, 505-2 corresponding to a first spectrum band, and four (4) SCs 510-1, . . . , 510-4 corresponding to a second spectrum band. The first spectrum band is a lower frequency band than the second frequency band. For example, the first spectrum band may correspond to frequencies less than 1 GHz and the second spectrum band may correspond to frequencies between 24-40 GHz.

Each pair of adjacent sector carriers (e.g., having partly or fully overlapping coverage with each other) has a corresponding set of requirements, such as a resiliency requirement and a mobility requirement. In some embodiments, the levels of the resiliency requirement and the mobility requirement (or the corresponding values of the affinity constraints and/or anti-affinity constraints) in each set of requirements may be based on the type or types of sector carriers included in each pair. In other embodiments, the levels (or values) may be specific to each pair.

As shown, a set of requirements 515 exists between adjacent “low band” SCs 505-1, 505-2 (high resiliency, high mobility). Between adjacent SCs of the “high band” SCs 510-1, . . . , 510-4, a set of requirements 520-1 exists between the SCs 510-1, 510-2 (low resiliency, high mobility), a set of requirements 520-2 exists between the SCs 510-2, 510-3 (low resiliency, high mobility), and a set of requirements 520-3 exists between the SCs 510-3, 510-4 (low resiliency, high mobility). For pairs of adjacent SCs between the low band and the high band, a set of requirements 525-1 exists between the SCs 505-1, 510-1 (high resiliency, medium mobility), a set of requirements 525-2 exists between the SCs 505-1, 510-2 (high resiliency, medium mobility), a set of requirements 525-3 exists between the SCs 505-2, 510-3 (high resiliency, medium mobility), and a set of requirements 525-4 exists between the SCs 505-2, 510-4 (high resiliency, medium mobility).

In the example shown in the diagram 500, the mobility requirement corresponds to a soft affinity constraint and the resiliency requirement corresponds to a hard anti-affinity constraint. Each server has a maximum capacity of two (2) pods, and each pod has a maximum capacity of two (2) SCs.

As mentioned above, the set of requirements 515 specifies a high resiliency requirement and a high mobility requirement between the SCs 505-1, 505-2 of the first spectrum band. Assuming that the high resiliency requirement of the set of requirements 515 corresponds to a hard constraint, the server 410-3 and the pod 420-15 are assigned to the SC 505-1, and the server 410-1 and the pod 420-1 are assigned to the SC 505-2. Stated another way, the SCs 505-1, 505-2 are assigned to different servers 410-3, 410-1 to meet the high resiliency requirement.

In an alternate implementation, the resiliency requirement of the set of requirements corresponds to a soft constraint. Based on the resiliency requirement (and in some cases, a priority of the resiliency requirement relative to the mobility requirement) the SCs 505-1, 505-2 may be assigned to a same server. The SCs 505-1, 505-2 may be assigned to a same pod or to different pods on the same server.

As mentioned above, the sets of requirements 520-1, 520-2, 520-3 specifies a low resiliency requirement and a high mobility requirement between the SCs 510-1, . . . , 510-4 of the second spectrum band. Assuming that the low resiliency requirement of the sets of requirements 520-1, 520-2, 520-3 corresponds to a soft constraint (and in some cases, based on a priority of the resiliency requirement relative to the mobility requirement), the server 410-2 is assigned to the SCs 510-1, . . . , 510-4. Considering the maximum capacity of the pods (two SCs each), the pod 420-5 is assigned to the SCs 510-1, 510-2, and the pod 420-6 is assigned to the SCs 510-3, 510-4. In total, three (3) servers 410-1, 410-2, 410-3 and four (4) pods 420-1, 420-5, 420-6, 420-15 are assigned to the six (6) SCs 505-1, 505-2, 510-1, . . . , 510-4.

In an alternate implementation, the resiliency requirement of the sets of requirements 520-1, 520-2, 520-3 corresponds to a hard constraint such that separate servers are assigned to the SCs 510-1, . . . , 510-4. In yet another alternate implementation, the resiliency requirement corresponds to a soft constraint, and the priority of the resiliency requirement relative to the mobility requirement is different, such that different servers and/or pods are assigned to the SCs 510-1, . . . , 510-4.

The set of requirements 525-1, 525-2, 525-3, 525-4 specifies a medium mobility requirement (affinity) and a high resiliency requirement (anti-affinity), which contradict each other. If the resiliency requirement corresponds a hard constraint, it will be satisfied at all times (assuming enough capacity, number of servers), and the assignment will be done such that overlapping low-band SCs and high-band SCs do not share same server. If the resiliency requirement corresponds to a soft constraint, the assignment will be done according to the priority/penalty values of the different requirements.

FIG. 5B illustrates an exemplary assignment of computing resources to support a plurality of sector carriers of a mobile network, according to one or more embodiments. The features in diagram 550 may be used in conjunction with other embodiments, for example, using the hierarchy of computing resources shown in FIG. 4.

In the example shown in the diagram 550, the mobility requirement again corresponds to a soft affinity constraint and the resiliency requirement corresponds to a hard anti-affinity constraint. However, each server has a maximum capacity of two (2) pods, and each pod has a maximum capacity of one (1) SC.

As mentioned above, the set of requirements 515 specifies a high resiliency requirement and a high mobility requirement between the SCs 505-1, 505-2 of the first spectrum band. Assuming that the high resiliency requirement of the set of requirements 515 corresponds to a hard constraint, the server 410-1 and the pod 420-1 are assigned to the SC 505-1, and the server 410-3 and the pod 420-16 are assigned to the SC 505-2. Stated another way, the SCs 505-1, 505-2 are assigned to different servers 410-1, 410-3 to meet the high resiliency requirement.

In an alternate implementation, the resiliency requirement of the set of requirements corresponds to a soft constraint. Based on the resiliency requirement (and in some cases, a priority of the resiliency requirement relative to the mobility requirement) the SCs 505-1, 505-2 may be assigned to a same server. The SCs 505-1, 505-2 may be assigned to a same pod or to different pods on the same server.

As mentioned above, the sets of requirements 520-1, 520-2, 520-3 specifies a low resiliency requirement and a high mobility requirement between the SCs 510-1, . . . , 510-4 of the second spectrum band. Assuming that the low resiliency requirement of the sets of requirements 520-1, 520-2, 520-3 corresponds to a soft constraint (and in some cases, based on a priority of the resiliency requirement relative to the mobility requirement), the server 410-2 is assigned to the SCs 510-1, 510-2, and the server 410-4 is assigned to the SCs 510-3, 510-4. Considering the maximum capacity of the pods (1 SC each), the pod 420-5 is assigned to the SC 510-1, the pod 420-6 is assigned to SC 510-2, the pod 420-17 is assigned to the SC 510-3, and the pod 420-18 is assigned to the SC 510-4. In total, four (4) servers 410-1, . . . , 410-4 and six (6) pods 420-1, 420-5, 420-6, 420-16, 420-17, 420-18 are assigned to the six (6) SCs 505-1, 505-2, 510-1, . . . , 510-4.

In an alternate implementation, the resiliency requirement of the sets of requirements 520-1, 520-2, 520-3 corresponds to a hard constraint such that separate servers are assigned to the SCs 510-1, . . . , 510-4. In yet another alternate implementation, the resiliency requirement corresponds to a soft constraint, and the priority of the resiliency requirement relative to the mobility requirement is different, such that different servers and/or pods are assigned to the SCs 510-1, . . . , 510-4.

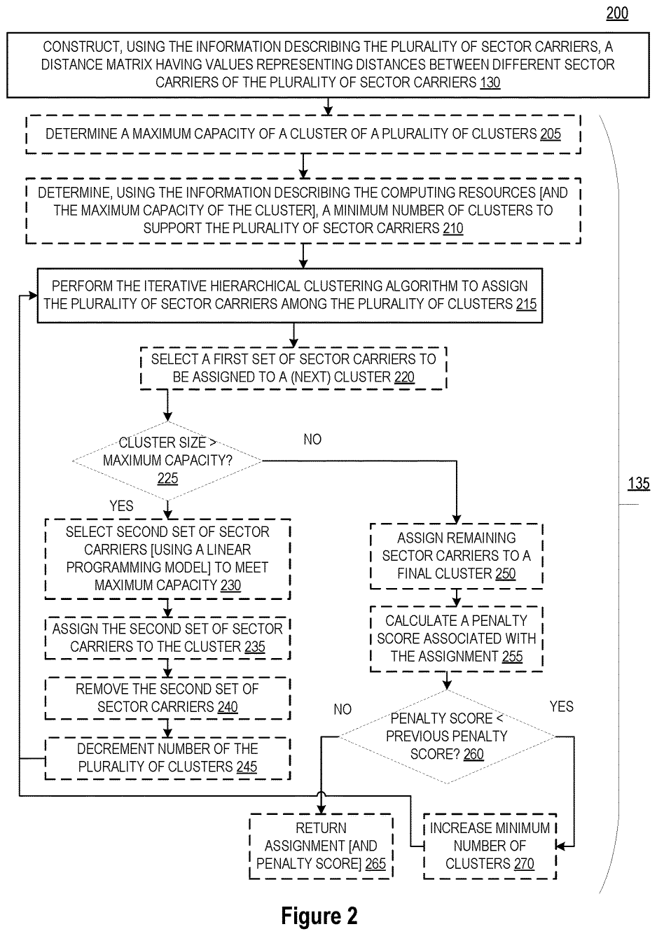

Refer now to FIG. 6A, which illustrates connectivity between network devices (NDs) within an exemplary network, as well as three exemplary implementations of the NDs, according to some embodiments of the invention. The features illustrated in FIG. 6A may be used in conjunction with other embodiments described herein. For example, some or all of the network devices 600A, . . . , 600-H may be examples of the electronic device 225 of FIG. 2, including a sector carrier resource assignment service 340 and/or an optional LP model service 350. As used herein, a network device is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

FIG. 6A shows NDs 600A-H, and their connectivity by way of lines between 600A-600B, 600B-600C, 600C-600D, 600D-600E, 600E-600F, 600F-600G, and 600A-600G, as well as between 600H and each of 600A, 600C, 600D, and 600G. These NDs are physical devices, and the connectivity between these NDs can be wireless or wired (often referred to as a link). An additional line extending from NDs 600A, 600E, and 600F illustrates that these NDs act as ingress and egress points for the network (and thus, these NDs are sometimes referred to as edge NDs; while the other NDs may be called core NDs).

Two of the exemplary ND implementations in FIG. 6A are: 1) a special-purpose network device 602 that uses custom application-specific integrated-circuits (ASICs) and a special-purpose operating system (OS); and 2) a general-purpose network device 604 that uses common off-the-shelf (COTS) processors and a standard OS.

The special-purpose network device 602 includes networking hardware 610 comprising a set of one or more processor(s) 612, forwarding resource(s) 614 (which typically include one or more ASICs and/or network processors), and physical network interfaces (NIs) 616 (through which network connections are made, such as those shown by the connectivity between NDs 600A-H), as well as non-transitory machine readable storage media 618 having stored therein networking software 620. During operation, the networking software 620 may be executed by the networking hardware 610 to instantiate a set of one or more networking software instance(s) 622. Each of the networking software instance(s) 622, and that part of the networking hardware 610 that executes that network software instance (be it hardware dedicated to that networking software instance and/or time slices of hardware temporally shared by that networking software instance with others of the networking software instance(s) 622), form a separate virtual network element 630A-R. Each of the virtual network element(s) (VNEs) 630A-R includes a control communication and configuration module 632A-R (sometimes referred to as a local control module or control communication module) and forwarding table(s) 634A-R, such that a given virtual network element (e.g., 630A) includes the control communication and configuration module (e.g., 632A), a set of one or more forwarding table(s) (e.g., 634A), and that portion of the networking hardware 610 that executes the virtual network element (e.g., 630A). In some embodiments, the functionality of the QUBO problem solver service 230-1, 230-2 may be included in the software 650. In other embodiments, the QUBO problem solver service 230-1, 230-2 may be implemented separate from the software 650 within the non-transitory machine readable storage media 648.

The special-purpose network device 602 is often physically and/or logically considered to include: 1) a ND control plane 624 (sometimes referred to as a control plane) comprising the processor(s) 612 that execute the control communication and configuration module(s) 632A-R; and 2) a ND forwarding plane 626 (sometimes referred to as a forwarding plane, a data plane, or a media plane) comprising the forwarding resource(s) 614 that utilize the forwarding table(s) 634A-R and the physical NIs 616. By way of example, where the ND is a router (or is implementing routing functionality), the ND control plane 624 (the processor(s) 612 executing the control communication and configuration module(s) 632A-R) is typically responsible for participating in controlling how data (e.g., packets) is to be routed (e.g., the next hop for the data and the outgoing physical NI for that data) and storing that routing information in the forwarding table(s) 634A-R, and the ND forwarding plane 626 is responsible for receiving that data on the physical NIs 616 and forwarding that data out the appropriate ones of the physical NIs 616 based on the forwarding table(s) 634A-R.

FIG. 6B illustrates an exemplary way to implement the special-purpose network device 602 according to some embodiments of the invention. FIG. 6B shows a special-purpose network device including cards 638 (typically hot pluggable). While in some embodiments the cards 638 are of two types (one or more that operate as the ND forwarding plane 626 (sometimes called line cards), and one or more that operate to implement the ND control plane 624 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VOIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 636 (e.g., a first full mesh coupling the line cards and a second full mesh coupling all of the cards).

Returning to FIG. 6A, the general-purpose network device 604 includes hardware 640 comprising a set of one or more processor(s) 642 (which are often COTS processors) (e.g., another example of the one or more processors 330) and physical NIs 646, as well as non-transitory machine-readable storage media 648 having stored therein software 650. During operation, the processor(s) 642 execute the software 650 to instantiate one or more sets of one or more applications 664A-R. While one embodiment does not implement virtualization, alternative embodiments may use different forms of virtualization. For example, in one such alternative embodiment the virtualization layer 654 represents the kernel of an operating system (or a shim executing on a base operating system) that allows for the creation of multiple instances 662A-R called software containers that may each be used to execute one (or more) of the sets of applications 664A-R; where the multiple software containers (also called virtualization engines, virtual private servers, or jails) are user spaces (typically a virtual memory space) that are separate from each other and separate from the kernel space in which the operating system is run; and where the set of applications running in a given user space, unless explicitly allowed, cannot access the memory of the other processes. In another such alternative embodiment the virtualization layer 654 represents a hypervisor (sometimes referred to as a virtual machine monitor (VMM)) or a hypervisor executing on top of a host operating system, and each of the sets of applications 664A-R is run on top of a guest operating system within an instance 662A-R called a virtual machine (which may in some cases be considered a tightly isolated form of software container) that is run on top of the hypervisor—the guest operating system and application may not know they are running on a virtual machine as opposed to running on a “bare metal” host electronic device, or through para-virtualization the operating system and/or application may be aware of the presence of virtualization for optimization purposes. In yet other alternative embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 640, directly on a hypervisor (in which case the unikernel is sometimes described as running within a LibOS virtual machine), or in a software container, embodiments can be implemented fully with unikernels running directly on a hypervisor represented by virtualization layer 654, unikernels running within software containers represented by instances 662A-R, or as a combination of unikernels and the above-described techniques (e.g., unikernels and virtual machines both run directly on a hypervisor, unikernels and sets of applications that are run in different software containers).

The instantiation of the one or more sets of one or more applications 664A-R, as well as virtualization if implemented, are collectively referred to as software instance(s) 652. Each set of applications 664A-R, corresponding virtualization construct (e.g., instance 662A-R) if implemented, and that part of the hardware 640 that executes them (be it hardware dedicated to that execution and/or time slices of hardware temporally shared), forms a separate virtual network element(s) 660A-R.

The virtual network element(s) 660A-R perform similar functionality to the virtual network element(s) 630A-R—e.g., similar to the control communication and configuration module(s) 632A and forwarding table(s) 634A (this virtualization of the hardware 640 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). While embodiments of the invention are illustrated with each instance 662A-R corresponding to one VNE 660A-R, alternative embodiments may implement this correspondence at a finer level granularity (e.g., line card virtual machines virtualize line cards, control card virtual machine virtualize control cards, etc.); it should be understood that the techniques described herein with reference to a correspondence of instances 662A-R to VNEs also apply to embodiments where such a finer level of granularity and/or unikernels are used.

In certain embodiments, the virtualization layer 654 includes a virtual switch that provides similar forwarding services as a physical Ethernet switch. Specifically, this virtual switch forwards traffic between instances 662A-R and the physical NI(s) 646, as well as optionally between the instances 662A-R; in addition, this virtual switch may enforce network isolation between the VNEs 660A-R that by policy are not permitted to communicate with each other (e.g., by honoring virtual local area networks (VLANs)).

The third exemplary ND implementation in FIG. 6A is a hybrid network device 606, which includes both custom ASICs/special-purpose OS and COTS processors/standard OS in a single ND or a single card within an ND. In certain embodiments of such a hybrid network device, a platform VM (i.e., a VM that that implements the functionality of the special-purpose network device 602) could provide for para-virtualization to the networking hardware present in the hybrid network device 606.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 630A-R, VNEs 660A-R, and those in the hybrid network device 606) receives data on the physical NIs (e.g., 616, 646) and forwards that data out the appropriate ones of the physical NIs (e.g., 616, 646). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services code point (DSCP) values.

FIG. 6C illustrates various exemplary ways in which VNEs may be coupled according to some embodiments of the invention. FIG. 6C shows VNEs 670A.1-670A.P (and optionally VNEs 670A.Q-670A.R) implemented in ND 600A and VNE 670H.1 in ND 600H. In FIG. 6C, VNEs 670A.1-P are separate from each other in the sense that they can receive packets from outside ND 600A and forward packets outside of ND 600A; VNE 670A.1 is coupled with VNE 670H.1, and thus they communicate packets between their respective NDs; VNE 670A.2-670A.3 may optionally forward packets between themselves without forwarding them outside of the ND 600A; and VNE 670A.P may optionally be the first in a chain of VNEs that includes VNE 670A.Q followed by VNE 670A.R (this is sometimes referred to as dynamic service chaining, where each of the VNEs in the series of VNEs provides a different service—e.g., one or more layer 4-7 network services). While FIG. 6C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 6A, for example, may form part of the Internet or a private network; and other electronic devices (not shown; such as end user devices including workstations, laptops, netbooks, tablets, palm tops, mobile phones, smartphones, phablets, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 6A may also host one or more such servers (e.g., in the case of the general purpose network device 604, one or more of the software instances 662A-R may operate as servers; the same would be true for the hybrid network device 606; in the case of the special-purpose network device 602, one or more such servers could also be run on a virtualization layer executed by the processor(s) 612); in which case the servers are said to be co-located with the VNEs of that ND.

A virtual network is a logical abstraction of a physical network (such as that in FIG. 6A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network-originated attacks, to avoid malformed route announcements), and management capabilities (e.g., full detection and processing).

FIG. 6D illustrates a network with a single network element on each of the NDs of FIG. 6A, and within this straight forward approach contrasts a traditional distributed approach (commonly used by traditional routers) with a centralized approach for maintaining reachability and forwarding information (also called network control), according to some embodiments of the invention. Specifically, FIG. 6D illustrates network elements (NEs) 670A-H with the same connectivity as the NDs 600A-H of FIG. 6A.

FIG. 6D illustrates that the distributed approach 672 distributes responsibility for generating the reachability and forwarding information across the NEs 670A-H; in other words, the process of neighbor discovery and topology discovery is distributed.

For example, where the special-purpose network device 602 is used, the control communication and configuration module(s) 632A-R of the ND control plane 624 typically include a reachability and forwarding information module to implement one or more routing protocols (e.g., an exterior gateway protocol such as Border Gateway Protocol (BGP), Interior Gateway Protocol(s) (IGP) (e.g., Open Shortest Path First (OSPF), Intermediate System to Intermediate System (IS-IS), Routing Information Protocol (RIP), Label Distribution Protocol (LDP), Resource Reservation Protocol (RSVP) (including RSVP-Traffic Engineering (TE): Extensions to RSVP for LSP Tunnels and Generalized Multi-Protocol Label Switching (GMPLS) Signaling RSVP-TE)) that communicate with other NEs to exchange routes, and then selects those routes based on one or more routing metrics. Thus, the NEs 670A-H (e.g., the processor(s) 612 executing the control communication and configuration module(s) 632A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 624. The ND control plane 624 programs the ND forwarding plane 626 with information (e.g., adjacency and route information) based on the routing structure(s). For example, the ND control plane 624 programs the adjacency and route information into one or more forwarding table(s) 634A-R (e.g., Forwarding Information Base (FIB), Label Forwarding Information Base (LFIB), and one or more adjacency structures) on the ND forwarding plane 626. For layer 2 forwarding, the ND can store one or more bridging tables that are used to forward data based on the layer 2 information in that data. While the above example uses the special-purpose network device 602, the same distributed approach 672 can be implemented on the general purpose network device 604 and the hybrid network device 606.

FIG. 6D illustrates that a centralized approach 674 (also known as software defined networking (SDN)) that decouples the system that makes decisions about where traffic is sent from the underlying systems that forwards traffic to the selected destination. The illustrated centralized approach 674 has the responsibility for the generation of reachability and forwarding information in a centralized control plane 676 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 676 has a south bound interface 682 with a data plane 680 (sometime referred to the infrastructure layer, network forwarding plane, or forwarding plane (which should not be confused with a ND forwarding plane)) that includes the NEs 670A-H (sometimes referred to as switches, forwarding elements, data plane elements, or nodes). The centralized control plane 676 includes a network controller 678, which includes a centralized reachability and forwarding information module 679 that determines the reachability within the network and distributes the forwarding information to the NEs 670A-H of the data plane 680 over the south bound interface 682 (which may use the OpenFlow protocol). Thus, the network intelligence is centralized in the centralized control plane 676 executing on electronic devices that are typically separate from the NDs.

For example, where the special-purpose network device 602 is used in the data plane 680, each of the control communication and configuration module(s) 632A-R of the ND control plane 624 typically include a control agent that provides the VNE side of the south bound interface 682. In this case, the ND control plane 624 (the processor(s) 612 executing the control communication and configuration module(s) 632A-R) performs its responsibility for participating in controlling how data (e.g., packets) is to be routed (e.g., the next hop for the data and the outgoing physical NI for that data) through the control agent communicating with the centralized control plane 676 to receive the forwarding information (and in some cases, the reachability information) from the centralized reachability and forwarding information module 679 (it should be understood that in some embodiments of the invention, the control communication and configuration module(s) 632A-R, in addition to communicating with the centralized control plane 676, may also play some role in determining reachability and/or calculating forwarding information-albeit less so than in the case of a distributed approach; such embodiments are generally considered to fall under the centralized approach 674, but may also be considered a hybrid approach).

While the above example uses the special-purpose network device 602, the same centralized approach 674 can be implemented with the general purpose network device 604 (e.g., each of the VNE 660A-R performs its responsibility for controlling how data (e.g., packets) is to be routed (e.g., the next hop for the data and the outgoing physical NI for that data) by communicating with the centralized control plane 676 to receive the forwarding information (and in some cases, the reachability information) from the centralized reachability and forwarding information module 679; it should be understood that in some embodiments of the invention, the VNEs 660A-R, in addition to communicating with the centralized control plane 676, may also play some role in determining reachability and/or calculating forwarding information-albeit less so than in the case of a distributed approach) and the hybrid network device 606. In fact, the use of SDN techniques can enhance the NFV techniques typically used in the general-purpose network device 604 or hybrid network device 606 implementations as NFV is able to support SDN by providing an infrastructure upon which the SDN software can be run, and NFV and SDN both aim to make use of commodity server hardware and physical switches.

FIG. 6D also shows that the centralized control plane 676 has a north bound interface 684 to an application layer 686, in which resides application(s) 688. The centralized control plane 676 has the ability to form virtual networks 692 (sometimes referred to as a logical forwarding plane, network services, or overlay networks (with the NEs 670A-H of the data plane 680 being the underlay network)) for the application(s) 688. Thus, the centralized control plane 676 maintains a global view of all NDs and configured NEs/VNEs, and it maps the virtual networks to the underlying NDs efficiently (including maintaining these mappings as the physical network changes either through hardware (ND, link, or ND component) failure, addition, or removal).

While FIG. 6D shows the distributed approach 672 separate from the centralized approach 674, the effort of network control may be distributed differently or the two combined in certain embodiments of the invention. For example: 1) embodiments may generally use the centralized approach (SDN) 674, but have certain functions delegated to the NEs (e.g., the distributed approach may be used to implement one or more of fault monitoring, performance monitoring, protection switching, and primitives for neighbor and/or topology discovery); or 2) embodiments of the invention may perform neighbor discovery and topology discovery via both the centralized control plane and the distributed protocols, and the results compared to raise exceptions where they do not agree. Such embodiments are generally considered to fall under the centralized approach 674, but may also be considered a hybrid approach.

While FIG. 6D illustrates the simple case where each of the NDs 600A-H implements a single NE 670A-H, it should be understood that the network control approaches described with reference to FIG. 6D also work for networks where one or more of the NDs 600A-H implement multiple VNEs (e.g., VNEs 630A-R, VNEs 660A-R, those in the hybrid network device 606). Alternatively or in addition, the network controller 678 may also emulate the implementation of multiple VNEs in a single ND. Specifically, instead of (or in addition to) implementing multiple VNEs in a single ND, the network controller 678 may present the implementation of a VNE/NE in a single ND as multiple VNEs in the virtual networks 692 (all in the same one of the virtual network(s) 692, each in different ones of the virtual network(s) 692, or some combination). For example, the network controller 678 may cause an ND to implement a single VNE (a NE) in the underlay network, and then logically divide up the resources of that NE within the centralized control plane 676 to present different VNEs in the virtual network(s) 692 (where these different VNEs in the overlay networks are sharing the resources of the single VNE/NE implementation on the ND in the underlay network).

On the other hand, FIGS. 6E and 6F respectively illustrate exemplary abstractions of NEs and VNEs that the network controller 678 may present as part of different ones of the virtual networks 692. FIG. 6E illustrates the simple case of where each of the NDs 600A-H implements a single NE 670A-H (see FIG. 6D), but the centralized control plane 676 has abstracted multiple of the NEs in different NDs (the NEs 670A-C and G-H) into (to represent) a single NE 670I in one of the virtual network(s) 692 of FIG. 6D, according to some embodiments of the invention. FIG. 6E shows that in this virtual network, the NE 670I is coupled to NE 670D and 670F, which are both still coupled to NE 670E.

FIG. 6F illustrates a case where multiple VNEs (VNE 670A.1 and VNE 670H.1) are implemented on different NDs (ND 600A and ND 600H) and are coupled to each other, and where the centralized control plane 676 has abstracted these multiple VNEs such that they appear as a single VNE 670T within one of the virtual networks 692 of FIG. 6D, according to some embodiments of the invention. Thus, the abstraction of a NE or VNE can span multiple NDs.

While some embodiments of the invention implement the centralized control plane 676 as a single entity (e.g., a single instance of software running on a single electronic device), alternative embodiments may spread the functionality across multiple entities for redundancy and/or scalability purposes (e.g., multiple instances of software running on different electronic devices).

Similar to the network device implementations, the electronic device(s) running the centralized control plane 676, and thus the network controller 678 including the centralized reachability and forwarding information module 679, may be implemented a variety of ways (e.g., a special purpose device, a general-purpose (e.g., COTS) device, or hybrid device). These electronic device(s) would similarly include processor(s), a set of one or more physical NIs, and a non-transitory machine-readable storage medium having stored thereon the centralized control plane software. For instance, FIG. 7 illustrates, a general-purpose control plane device 704 including hardware 740 comprising a set of one or more processor(s) 742 (which are often COTS processors) and physical NIs 746, as well as non-transitory machine-readable storage media 748 having stored therein centralized control plane (CCP) software 750.

In embodiments that use compute virtualization, the processor(s) 742 typically execute software to instantiate a virtualization layer 754 (e.g., in one embodiment the virtualization layer 754 represents the kernel of an operating system (or a shim executing on a base operating system) that allows for the creation of multiple instances 762A-R called software containers (representing separate user spaces and also called virtualization engines, virtual private servers, or jails) that may each be used to execute a set of one or more applications; in another embodiment the virtualization layer 754 represents a hypervisor (sometimes referred to as a virtual machine monitor (VMM)) or a hypervisor executing on top of a host operating system, and an application is run on top of a guest operating system within an instance 762A-R called a virtual machine (which in some cases may be considered a tightly isolated form of software container) that is run by the hypervisor; in another embodiment, an application is implemented as a unikernel, which can be generated by compiling directly with an application only a limited set of libraries (e.g., from a library operating system (LibOS) including drivers/libraries of OS services) that provide the particular OS services needed by the application, and the unikernel can run directly on hardware 740, directly on a hypervisor represented by virtualization layer 754 (in which case the unikernel is sometimes described as running within a LibOS virtual machine), or in a software container represented by one of instances 762A-R). Again, in embodiments where compute virtualization is used, during operation an instance of the CCP software 750 (illustrated as CCP instance 776A) is executed (e.g., within the instance 762A) on the virtualization layer 754. In embodiments where compute virtualization is not used, the CCP instance 776A is executed, as a unikernel or on top of a host operating system, on the “bare metal” general purpose control plane device 704. The instantiation of the CCP instance 776A, as well as the virtualization layer 754 and instances 762A-R if implemented, are collectively referred to as software instance(s) 752.

In some embodiments, the CCP instance 776A includes a network controller instance 778. The network controller instance 778 includes a centralized reachability and forwarding information module instance 779 (which is a middleware layer providing the context of the network controller 678 to the operating system and communicating with the various NEs), and an CCP application layer 780 (sometimes referred to as an application layer) over the middleware layer (providing the intelligence required for various network operations such as protocols, network situational awareness, and user-interfaces). At a more abstract level, this CCP application layer 780 within the centralized control plane 676 works with virtual network view(s) (logical view(s) of the network) and the middleware layer provides the conversion from the virtual networks to the physical view.

The centralized control plane 676 transmits relevant messages to the data plane 680 based on CCP application layer 780 calculations and middleware layer mapping for each flow. A flow may be defined as a set of packets whose headers match a given pattern of bits; in this sense, traditional IP forwarding is also flow-based forwarding where the flows are defined by the destination IP address for example; however, in other implementations, the given pattern of bits used for a flow definition may include more fields (e.g., 7 or more) in the packet headers. Different NDs/NEs/VNEs of the data plane 680 may receive different messages, and thus different forwarding information. The data plane 680 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities—for specific fields in the packet header, or for some other packet content), and a set of one or more actions for the data plane to take on receiving a matching packet. For example, an action may be to push a header onto the packet, for the packet using a particular port, flood the packet, or simply drop the packet. Thus, a forwarding table entry for IPV4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the data plane 680, the packet (or a subset of the packet header and content) is typically forwarded to the centralized control plane 676. The centralized control plane 676 will then program forwarding table entries into the data plane 680 to accommodate packets belonging to the flow of the unknown packet. Once a specific forwarding table entry has been programmed into the data plane 680 by the centralized control plane 676, the next packet with matching credentials will match that forwarding table entry and take the set of actions associated with that matched entry.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

Next hop selection by the routing system for a given destination may resolve to one path (that is, a routing protocol may generate one next hop on a shortest path); but if the routing system determines there are multiple viable next hops (that is, the routing protocol generated forwarding solution offers more than one next hop on a shortest path-multiple equal cost next hops), some additional criteria is used—for instance, in a connectionless network, Equal Cost Multi Path (ECMP) (also known as Equal Cost Multi Pathing, multipath forwarding and IP multipath) may be used (e.g., typical implementations use as the criteria particular header fields to ensure that the packets of a particular packet flow are always forwarded on the same next hop to preserve packet flow ordering). For purposes of multipath forwarding, a packet flow is defined as a set of packets that share an ordering constraint. As an example, the set of packets in a particular TCP transfer sequence need to arrive in order, else the TCP logic will interpret the out of order delivery as congestion and slow the TCP transfer rate down.

A Layer 3 (L3) Link Aggregation (LAG) link is a link directly connecting two NDs with multiple IP-addressed link paths (each link path is assigned a different IP address), and a load distribution decision across these different link paths is performed at the ND forwarding plane; in which case, a load distribution decision is made between the link paths.

Some NDs include functionality for authentication, authorization, and accounting (AAA) protocols (e.g., RADIUS (Remote Authentication Dial-In User Service), Diameter, and/or TACACS+ (Terminal Access Controller Access Control System Plus). AAA can be provided through a client/server model, where the AAA client is implemented on a ND and the AAA server can be implemented either locally on the ND or on a remote electronic device coupled with the ND. Authentication is the process of identifying and verifying a subscriber. For instance, a subscriber might be identified by a combination of a username and a password or through a unique key. Authorization determines what a subscriber can do after being authenticated, such as gaining access to certain electronic device information resources (e.g., through the use of access control policies). Accounting is recording user activity. By way of a summary example, end user devices may be coupled (e.g., through an access network) through an edge ND (supporting AAA processing) coupled to core NDs coupled to electronic devices implementing servers of service/content providers. AAA processing is performed to identify for a subscriber the subscriber record stored in the AAA server for that subscriber. A subscriber record includes a set of attributes (e.g., subscriber name, password, authentication information, access control information, rate-limiting information, policing information) used during processing of that subscriber's traffic.

Certain NDs (e.g., certain edge NDs) internally represent end user devices (or sometimes customer premise equipment (CPE) such as a residential gateway (e.g., a router, modem)) using subscriber circuits. A subscriber circuit uniquely identifies within the ND a subscriber session and typically exists for the lifetime of the session. Thus, a ND typically allocates a subscriber circuit when the subscriber connects to that ND, and correspondingly de-allocates that subscriber circuit when that subscriber disconnects. Each subscriber session represents a distinguishable flow of packets communicated between the ND and an end user device (or sometimes CPE such as a residential gateway or modem) using a protocol, such as the point-to-point protocol over another protocol (PPPoX) (e.g., where X is Ethernet or Asynchronous Transfer Mode (ATM)), Ethernet, 802.1Q Virtual LAN (VLAN), Internet Protocol, or ATM). A subscriber session can be initiated using a variety of mechanisms (e.g., manual provisioning a dynamic host configuration protocol (DHCP), DHCP/client-less internet protocol service (CLIPS) or Media Access Control (MAC) address tracking). For example, the point-to-point protocol (PPP) is commonly used for digital subscriber line (DSL) services and requires installation of a PPP client that enables the subscriber to enter a username and a password, which in turn may be used to select a subscriber record. When DHCP is used (e.g., for cable modem services), a username typically is not provided; but in such situations other information (e.g., information that includes the MAC address of the hardware in the end user device (or CPE)) is provided. The use of DHCP and CLIPS on the ND captures the MAC addresses and uses these addresses to distinguish subscribers and access their subscriber records.

A virtual circuit (VC), synonymous with virtual connection and virtual channel, is a connection oriented communication service that is delivered by means of packet mode communication. Virtual circuit communication resembles circuit switching, since both are connection oriented, meaning that in both cases data is delivered in correct order, and signaling overhead is required during a connection establishment phase. Virtual circuits may exist at different layers. For example, at layer 4, a connection oriented transport layer datalink protocol such as Transmission Control Protocol (TCP) may rely on a connectionless packet switching network layer protocol such as IP, where different packets may be routed over different paths, and thus be delivered out of order. Where a reliable virtual circuit is established with TCP on top of the underlying unreliable and connectionless IP protocol, the virtual circuit is identified by the source and destination network socket address pair, i.e. the sender and receiver IP address and port number. However, a virtual circuit is possible since TCP includes segment numbering and reordering on the receiver side to prevent out-of-order delivery. Virtual circuits are also possible at Layer 3 (network layer) and Layer 2 (datalink layer); such virtual circuit protocols are based on connection oriented packet switching, meaning that data is always delivered along the same network path, i.e. through the same NEs/VNEs. In such protocols, the packets are not routed individually and complete addressing information is not provided in the header of each data packet; only a small virtual channel identifier (VCI) is required in each packet; and routing information is transferred to the NEs/VNEs during the connection establishment phase; switching only involves looking up the virtual channel identifier in a table rather than analyzing a complete address. Examples of network layer and datalink layer virtual circuit protocols, where data always is delivered over the same path: X.25, where the VC is identified by a virtual channel identifier (VCI); Frame relay, where the VC is identified by a VCI; Asynchronous Transfer Mode (ATM), where the circuit is identified by a virtual path identifier (VPI) and virtual channel identifier (VCI) pair; General Packet Radio Service (GPRS); and Multiprotocol label switching (MPLS), which can be used for IP over virtual circuits (Each circuit is identified by a label).

Certain NDs (e.g., certain edge NDs) use a hierarchy of circuits. The leaf nodes of the hierarchy of circuits are subscriber circuits. The subscriber circuits have parent circuits in the hierarchy that typically represent aggregations of multiple subscriber circuits, and thus the network segments and elements used to provide access network connectivity of those end user devices to the ND. These parent circuits may represent physical or logical aggregations of subscriber circuits (e.g., a virtual local area network (VLAN), a permanent virtual circuit (PVC) (e.g., for Asynchronous Transfer Mode (ATM)), a circuit-group, a channel, a pseudo-wire, a physical NI of the ND, and a link aggregation group). A circuit-group is a virtual construct that allows various sets of circuits to be grouped together for configuration purposes, for example aggregate rate control. A pseudo-wire is an emulation of a layer 2 point-to-point connection-oriented service. A link aggregation group is a virtual construct that merges multiple physical NIs for purposes of bandwidth aggregation and redundancy. Thus, the parent circuits physically or logically encapsulate the subscriber circuits.

Each VNE (e.g., a virtual router, a virtual bridge (which may act as a virtual switch instance in a Virtual Private LAN Service (VPLS) is typically independently administrable. For example, in the case of multiple virtual routers, each of the virtual routers may share system resources but is separate from the other virtual routers regarding its management domain, AAA (authentication, authorization, and accounting) name space, IP address, and routing database(s). Multiple VNEs may be employed in an edge ND to provide direct network access and/or different classes of services for subscribers of service and/or content providers.

Within certain NDs, “interfaces” that are independent of physical NIs may be configured as part of the VNEs to provide higher-layer protocol and service information (e.g., Layer 3 addressing). The subscriber records in the AAA server identify, in addition to the other subscriber configuration requirements, to which context (e.g., which of the VNEs/NEs) the corresponding subscribers should be bound within the ND. As used herein, a binding forms an association between a physical entity (e.g., physical NI, channel) or a logical entity (e.g., circuit such as a subscriber circuit or logical circuit (a set of one or more subscriber circuits)) and a context's interface over which network protocols (e.g., routing protocols, bridging protocols) are configured for that context. Subscriber data flows on the physical entity when some higher-layer protocol interface is configured and associated with that physical entity.

Some NDs provide support for implementing VPNs (Virtual Private Networks) (e.g., Layer 2 VPNs and/or Layer 3 VPNs). For example, the ND where a provider's network and a customer's network are coupled are respectively referred to as PEs (Provider Edge) and CEs (Customer Edge). In a Layer 2 VPN, forwarding typically is performed on the CE(s) on either end of the VPN and traffic is sent across the network (e.g., through one or more PEs coupled by other NDs). Layer 2 circuits are configured between the CEs and PEs (e.g., an Ethernet port, an ATM permanent virtual circuit (PVC), a Frame Relay PVC). In a Layer 3 VPN, routing typically is performed by the PEs. By way of example, an edge ND that supports multiple VNEs may be deployed as a PE; and a VNE may be configured with a VPN protocol, and thus that VNE is referred as a VPN VNE.

Some NDs provide support for VPLS (Virtual Private LAN Service). For example, in a VPLS network, end user devices access content/services provided through the VPLS network by coupling to CEs, which are coupled through PEs coupled by other NDs. VPLS networks can be used for implementing triple play network applications (e.g., data applications (e.g., high-speed Internet access), video applications (e.g., television service such as IPTV (Internet Protocol Television), VOD (Video-on-Demand) service), and voice applications (e.g., VoIP (Voice over Internet Protocol) service)), VPN services, etc. VPLS is a type of layer 2 VPN that can be used for multi-point connectivity. VPLS networks also allow end use devices that are coupled with CEs at separate geographical locations to communicate with each other across a Wide Area Network (WAN) as if they were directly attached to each other in a Local Area Network (LAN) (referred to as an emulated LAN).

In VPLS networks, each CE typically attaches, possibly through an access network (wired and/or wireless), to a bridge module of a PE via an attachment circuit (e.g., a virtual link or connection between the CE and the PE). The bridge module of the PE attaches to an emulated LAN through an emulated LAN interface. Each bridge module acts as a “Virtual Switch Instance” (VSI) by maintaining a forwarding table that maps MAC addresses to pseudowires and attachment circuits. PEs forward frames (received from CEs) to destinations (e.g., other CEs, other PEs) based on the MAC destination address field included in those frames.

Returning to FIG. 1, the method 100 proceeds to block 130, where the electronic device 325 (e.g., the sector carrier resource assignment service 340) uses the information describing the plurality of sector carriers to construct a distance matrix 355 having values representing distances between different sector carriers of the plurality of sector carriers. In some embodiments, constructing the distance matrix 355 comprises assigning the values based on a presence of one or both of affinity constraint(s) (e.g., a mobility requirement) and anti-affinity constraint(s) (e.g., a resiliency requirement) between the different sector carriers of the pairs of the plurality of sector carriers. For example, a greater mobility requirement corresponds to a greater affinity between sector carriers and therefore a smaller distance value, and a greater resiliency requirement corresponds to a greater anti-affinity between sector carriers and therefore a greater distance value.

As shown in the diagrams 500, 550 of FIGS. 5A, 5B, the sets of requirements 515, 520-1, 520-2, 520-3, 525-1, 525-2, 525-3, 525-4 are defined between pairs of adjacent SCs. Each set of requirements includes a resiliency requirement and mobility requirement, although other implementations may include different compositions of requirements.

In some embodiments, when determining values of the distance matrix 355, the mobility requirement is considered a “transitive” feature, such that the affinity constraint is considered both for pairs of sector carriers that are adjacent to each other (also referred to as a “direct” relationship), and for pairs of sector carriers that are non-adjacent (e.g., having one or more other sector carriers disposed between the pair; also referred to as an “indirect” relationship). In some embodiments, in determining values of the distance matrix 355, the resiliency requirement is considered a “non-transitive” feature, such that the anti-affinity constraint is considered for pairs of adjacent sector carriers but not for pairs of non-adjacent sector carriers.

In some embodiments, the values of the distance matrix 355 may be calculated according to Table 1:

TABLE 1

| | | | Example |
|---|---|---|---|
| | Requirement(s) | Condition | values |
| Self-distance | | | 0 |
| Direct SCs | Mobility (WM) | | 1 |
| | Resiliency (WR) | WR > WM | (Diameter + 1) |
| | WM and WR | f (WR, WM) | (WR − WM) |
| Indirect SCs | | f (WM, Distance) | (WM × Min |
| | | | Path Length) |

In some embodiments, the self-distance for a particular sector carrier (e.g., from the sector carrier to itself) is represented in the distance matrix 355 as a zero value.

In some embodiments, for a pair of adjacent (direct) sector carriers having a mobility requirement, the distance between the sector carriers may be calculated as a mobility weight WM that is based on the value of the affinity constraint of the set of requirements. For example, as the mobility requirement incentivizes the sector carriers to be placed close to each other, the mobility weight WM may be assigned a relatively small value to reflect a smaller distance between the sector carriers. As shown in Table 1, the mobility weight WM is assigned a value of “1”.

In some embodiments, for a pair of adjacent sector carriers having a resiliency requirement, the distance between the sector carriers may be calculated as a resiliency weight WR that is based on the value of the anti-affinity constraint of the set of requirements. For example, as the resiliency requirement incentivizes the sector carriers to be placed further from each other, the resiliency weight WR may be assigned a relatively large value to reflect a larger distance between the sector carriers. In some embodiments, the resiliency weight WR is assigned a greater value than the mobility weight WM, as reflected by the Condition WR>WM. As the resiliency weight WR generally represents a greater distance than the mobility weight WM, in some embodiments values of the resiliency weight WR may be bounded by a maximum distance of the plurality of sector carriers of the mobile network 300 (e.g., according to the graphical depiction in the diagrams 500, 550 of FIGS. 5A, 5B). As shown in Table 1, the resiliency weight WR may be assigned a value that is the Diameter (e.g., a width) of the graph, representing a maximum distance between any two sector carriers, plus 1.

In some embodiments, for a pair of adjacent sector carriers having both a mobility requirement and a resiliency requirement, the distance between the sector carriers may be calculated as a function of the mobility requirement and the resiliency requirement (as reflected by the Condition f(WR, WM)). As the mobility requirement and the resiliency requirement tend to counteract each other, the function may offset the effect of the resiliency requirement (e.g., tending toward a greater distance) using the effect of the mobility requirement (e.g., tending toward a smaller distance). In the example shown in Table 1, the distance may be calculated as an arithmetic difference between the resiliency weight WR and the mobility weight WM (that is, WR-WM). Other arithmetic and/or logical functions are also contemplated. Further, the personal of ordinary skill will understand that the relative values (or ranges of values) of the resiliency weight WR and of the mobility weight WM, as well as the function may be selected to cause the values of the distance matrix 355 to fall within a desired range of distances.

As discussed above, the resiliency requirement may be considered a “non-transitive” feature, such that the anti-affinity constraint is not used to calculate distances for pairs of non-adjacent sector carriers. In some embodiments, for a pair of non-adjacent sector carriers, the distance between the sector carriers used in the distance matrix 355 may be calculated as a function of the mobility requirement and an actual distance between the sector carriers, as reflected by the Condition f(WM, Distance). In the example shown in Table 1, the distance may be calculated as the arithmetic product of the mobility weight WM and a minimum path length (that is, WM×Min Path Length) between the sector carriers (e.g., an integer number reflecting one or more intermediate sector carriers). Other arithmetic and/or logical functions are also contemplated.

One example of the distance matrix 355 using the techniques illustrated in Table 1 is provided in Table 2. More specifically, Table 2 represents an example distance matrix 355 for a mobile network 300 having twenty (20) sector carriers (indexed from 0-19).

TABLE 2

| | 0 | 1 | 2 | 3 | 4 | 5 | 6 | 7 | 8 | 9 | 10 | 11 | 12 | 13 | 14 | 15 | 16 | 17 | 18 | 19 |
|---|---|---|---|---|---|---|---|---|---|---|---|---|---|---|---|---|---|---|---|---|
| 0 | 0 | 2 | 1 | 1 | 1 | 1 | 5 | 2 | 1 | 1 | 2 | 5 | 5 | 1 | 5 | 1 | 1 | 2 | 1 | 5 |
| 1 | 2 | 0 | 2 | 2 | 2 | 2 | 1 | 2 | 5 | 2 | 5 | 2 | 2 | 2 | 5 | 2 | 5 | 5 | 5 | 2 |
| 2 | 1 | 2 | 0 | 1 | 5 | 5 | 5 | 2 | 1 | 1 | 5 | 5 | 1 | 1 | 1 | 1 | 5 | 2 | 2 | 1 |
| 3 | 1 | 2 | 1 | 0 | 2 | 5 | 2 | 1 | 2 | 1 | 2 | 2 | 5 | 1 | 1 | 1 | 1 | 2 | 5 | 1 |
| 4 | 1 | 2 | 5 | 2 | 0 | 1 | 5 | 2 | 1 | 1 | 1 | 1 | 2 | 1 | 2 | 1 | 1 | 2 | 2 | 2 |
| 5 | 1 | 2 | 5 | 5 | 1 | 0 | 2 | 2 | 2 | 5 | 1 | 1 | 1 | 1 | 5 | 1 | 1 | 2 | 1 | 5 |
| 6 | 5 | 1 | 5 | 2 | 5 | 2 | 0 | 2 | 5 | 5 | 2 | 2 | 2 | 5 | 2 | 5 | 2 | 1 | 2 | 2 |
| 7 | 2 | 2 | 2 | 1 | 2 | 2 | 2 | 0 | 2 | 2 | 1 | 1 | 1 | 5 | 1 | 1 | 2 | 2 | 5 | 1 |
| 8 | 1 | 5 | 1 | 2 | 1 | 2 | 5 | 2 | 0 | 1 | 1 | 5 | 1 | 1 | 1 | 1 | 5 | 5 | 1 | 2 |
| 9 | 1 | 2 | 1 | 1 | 1 | 5 | 5 | 2 | 1 | 0 | 2 | 2 | 5 | 1 | 1 | 5 | 1 | 5 | 1 | 1 |
| 10 | 2 | 5 | 5 | 2 | 1 | 1 | 2 | 1 | 1 | 2 | 0 | 1 | 2 | 5 | 1 | 2 | 1 | 2 | 1 | 1 |
| 11 | 5 | 2 | 5 | 2 | 1 | 1 | 2 | 1 | 5 | 2 | 1 | 0 | 1 | 5 | 1 | 2 | 1 | 2 | 1 | 1 |
| 12 | 5 | 2 | 1 | 5 | 2 | 1 | 2 | 1 | 1 | 5 | 2 | 1 | 0 | 1 | 1 | 1 | 5 | 2 | 5 | 5 |
| 13 | 1 | 2 | 1 | 1 | 1 | 1 | 5 | 5 | 1 | 1 | 5 | 5 | 1 | 0 | 1 | 1 | 2 | 5 | 5 | 5 |
| 14 | 5 | 5 | 1 | 1 | 2 | 5 | 2 | 1 | 1 | 1 | 1 | 1 | 1 | 1 | 0 | 1 | 1 | 2 | 5 | 1 |
| 15 | 1 | 2 | 1 | 1 | 1 | 1 | 5 | 1 | 1 | 5 | 2 | 2 | 1 | 1 | 1 | 0 | 5 | 2 | 5 | 1 |
| 16 | 1 | 5 | 5 | 1 | 1 | 1 | 2 | 2 | 5 | 1 | 1 | 1 | 5 | 2 | 1 | 5 | 0 | 2 | 1 | 1 |
| 17 | 2 | 5 | 2 | 2 | 2 | 2 | 1 | 2 | 5 | 5 | 2 | 2 | 2 | 5 | 2 | 2 | 2 | 0 | 2 | 2 |
| 18 | 1 | 5 | 2 | 5 | 2 | 1 | 2 | 5 | 1 | 1 | 1 | 1 | 5 | 5 | 5 | 5 | 1 | 2 | 0 | 5 |
| 19 | 5 | 2 | 1 | 1 | 2 | 5 | 2 | 1 | 2 | 1 | 1 | 1 | 5 | 5 | 1 | 1 | 1 | 2 | 5 | 0 |

Notably, the distance matrix 355 is symmetric, with zero values along its main diagonal (corresponding to self-distance values). Assuming that the mobility weight WM equals “1” and that the resiliency weight WR equals “6”, those adjacent (“direct”) sector carriers having both a mobility requirement and a resiliency requirement have a weight of “5” (that is, WR−WM). Assume also that the minimum path length between the sector carriers of each indirect pair is “2”.

Although the distance matrix 355 is depicted in a simplified form, note further that some implementations of the mobile network 300 may include a plurality of sector carriers that are arranged such that certain pairs of sector carriers are disjoint (i.e., no path exists therebetween). In such embodiments, each disjoint graph may be solved independently using the techniques discussed herein.

At block 135, the electronic device applies, using the distance matrix and information describing the computing resources, an iterative hierarchical clustering algorithm to the plurality of sector carriers to assign the plurality of sector carriers among the plurality of electronic devices. The method 100 ends following completion of block 135.

Refer now to FIG. 2, which illustrates a method 200 of iterative hierarchical clustering of a plurality of sector carriers, according to one or more embodiments. The method 200 may be used in conjunction with other embodiments, for example, as one example implementation of portions of the method 100 of FIG. 1. The method 200 begins at block 130, where a distance matrix is constructed using the information describing the plurality of sector carriers. Block 130 is discussed in greater detail above.

In some embodiments, block 135 includes some or all of blocks 205, 210, . . . , 270. At optional block 205, the electronic device 325 (e.g., the sector carrier resource assignment service 340) determines a maximum capacity of a cluster of a plurality of clusters, to which the plurality of sector carriers will be assigned. In some embodiments, each cluster corresponds to a respective electronic device (e.g., a distinct server) of the mobile network 300. In some embodiments, the maximum capacity of the cluster is the same for all of the plurality of clusters. In other embodiments, determining the maximum capacity comprises determining multiple values of maximum capacity, corresponding to different ones of the plurality of clusters (e.g., some clusters may have a greater or lesser maximum capacity). The maximum capacity may be provided in any suitable form, such as a maximum number of sector carriers that may be assigned to the cluster, or in terms of physical and/or virtual computing resources of the cluster, from which the maximum number of sector carriers may be determined. In some embodiments, the maximum capacity of the cluster is received as user input to the electronic device 325. In other embodiments, the maximum capacity of the cluster may be determined programmatically from the information describing the computing resources.

At optional block 210, the electronic device 325 determines, using the information describing the computing resources (and optionally, the maximum capacity of the cluster), a minimum number of clusters to support the plurality of sector carriers. In some embodiments, determining the minimum number of clusters comprises an arithmetic division of the plurality of sector carriers by the maximum capacity of the cluster. In other embodiments, determining the minimum number of clusters comprises estimating the minimum number of clusters. In yet other embodiments, the minimum number of clusters is received as user input to the electronic device 325.

At block 215, the electronic device 325 performs an iterative hierarchical clustering algorithm to assign the plurality of sector carriers among the plurality of clusters. Any suitable iterative hierarchical clustering algorithms are contemplated. In some embodiments, an agglomerative clustering approach divides the sector carriers, represented in the distance matrix 355, into several clusters such that the sector carriers that are grouped into a same cluster that are closer in terms of distance. The agglomerative clustering approach recursively merges multiple clusters of the sector carriers.

At optional block 220, and following the hierarchical clustering operation, the electronic device 325 selects a first set of sector carriers that are to be assigned to a (next) cluster. At optional block 225, the electronic device 325 determines whether the cluster size (as defined by the selected first set of sector carriers) is greater than the maximum capacity of the cluster. If the cluster size is larger than the maximum capacity of the cluster (“YES”), the method 200 proceeds to block 230.

At optional block 230, the electronic device 325 selects a second set of sector carriers to meet the maximum capacity of the cluster. Stated another way, the electronic device 325 filters one or more sector carriers from the first set to form the second set. In some embodiments, the electronic device 325 selects the second set of sector carriers using random selection or using any other suitable selection algorithm.

In some embodiments, the electronic device 325 (e.g., using the optional linear programming (LP) model service 350) selects the second set of sector carriers using a LP model. Using the LP model, the electronic device 325 selects the second set of sector carriers that are closest (e.g., a least distance) to each other. As discussed above, affinity constraint(s) and anti-affinity constraint(s) are defined between different sector carriers. Generally, one or more penalty terms are added to an objective function of the LP model for each sector carrier assignment, and the penalty term(s) are greater where the affinity constraint(s) and/or anti-affinity constraint(s) are not met. In one example implementation, for violating a resiliency requirement a relative high penalty value (P1) is added to the objective function. For violating a high mobility requirement, a smaller penalty value (P2<P1) is added to the objective function. For violating a medium mobility requirement, a much smaller penalty value (P3<<P1) is added to the total penalty.

The objective function of the LP model may thus be modeled as a minimization problem. In some embodiments, the second set of sector carriers is selected to correspond to the combination of sector carriers that yields a minimum value of the objective function.

At optional block 235, the electronic device 325 assigns the second set of sector carriers to the cluster. At optional block 240, the electronic device 325 removes the second set of sector carriers from the plurality of sector carriers (such that the sector carriers of the second set are not assigned to any other cluster in this assignment).

At optional block 245, the electronic device 325 decrements the number of the plurality of clusters, and the method 200 returns to block 215 to perform the iterative hierarchical clustering algorithm with the decremented number of the plurality of clusters. The method 200 repeats blocks 215, 220, . . . , 245 until at block 225 the cluster size is not greater than the maximum capacity of the cluster (“NO”). In this way, the electronic device 325 maximizes the utilization of the clusters, reducing the costs associated with the overall number of clusters required to support the plurality of sector carriers, the energy required to operate the clusters, and so forth.

At block 225, when the cluster size is not greater than the maximum capacity of the cluster (“NO”), the method 200 proceeds to optional block 250, where the electronic device 325 assigns the remaining sector carriers of the plurality of sector carriers to a final cluster of the plurality of clusters. At optional block 255, the electronic device 325 calculates a penalty score associated with the assignment. In some embodiments, the electronic device 325 (e.g., using the optional linear programming (LP) model service 350) calculates the penalty score using a LP model, which may be configured similarly to the LP model described above.

At optional block 260, the electronic device 325 determines whether the penalty score is less than a previous penalty score, which corresponds to a previous assignment of the plurality of sector carriers to the plurality of clusters. If the penalty score is less (“YES”), the decreasing trend indicates that it may still be possible to further optimize the assignment (e.g., to yield a smaller penalty score). The method 200 proceeds to block 270, where the electronic device 325 increases the minimum number of clusters, and returns to block 215 to perform the iterative hierarchical clustering algorithm using the increased minimum number of clusters.

At the optional block 260, when the penalty score is greater than a previous penalty score (“NO”), this indicates that no further optimization is possible. The method 200 proceeds to block 265, where the electronic device 325 returns the assignment associated with the penalty score, and optionally the penalty score itself.

In some embodiments, the assignment of block 265 represents a first stage of processing that allocates the plurality of sector carriers to particular electronic device(s) (e.g., server(s)) of the mobile network 300. In some embodiments, the electronic device 325 further performs a second stage of processing to distribute the assigned sector carriers into virtualization unit(s) (e.g., pods) of the respective electronic device(s). In some embodiments, the first stage processing operates using an assumption of a single virtualization unit per electronic device, where the single virtualization unit can provide the entire resource capacity of the electronic device. The assumption of a single virtualization unit allows sector carriers with high mobility requirements to be prioritized over sector carriers with medium mobility requirements.

In some embodiments, the virtual resource capacity constraints are introduced in the second stage of processing. Beneficially, using the two-stage approach reduces the number of optimization variables to be solved by a factor of the number of possible virtualization units per electronic device, which typically provides an order of magnitude in complexity gain. In this way, the two-stage approach may reduce the computing resources (e.g., CPU cycles, memory) that are required to perform the optimization, and may be completed more quickly.

An example sequence of the method 200 will now be described with respect to the example distance matrix 355 provided in Table 2. Assume that the information describing the computing resources of the mobile network 300 indicates three (3) servers (corresponding to three (3) clusters), and that the maximum capacity of each server is eight (8) sector carriers.

The electronic device 325 performs a first iteration of the iterative hierarchical clustering algorithm (at block 215) and assigns the sector carriers as follows:

| Cluster | Sector carriers |
|---|---|
| 0 | 4, 5, 7, 10, 11, 12, 14, 15, 16, 17, 18, 19 |
| 1 | 1, 6 |
| 2 | 0, 2, 3, 8, 9, 13 |

The number of sector carriers (12) that are initially to be assigned to Cluster 0 exceeds the maximum capacity of the cluster (8). The electronic device 325 selects (at block 230) a second set of sector carriers for Cluster 0, e.g., using a linear programming model or other suitable techniques. The four (4) additional sector carriers (Sector carriers 16, 17, 18, 19) are not selected. The electronic device 325 assigns (at block 235) the sector carriers as follows:

| Cluster | Sector carriers |
|---|---|
| 0 | 4, 5, 7, 10, 11, 12, 14, 15 |

The second set of sector carriers for Carrier 0 are removed (at block 240) so that these sector carriers are not subsequently assigned to another cluster. The distance matrix 355 is updated to remove the second set of sector carriers. The number of the plurality of clusters is decremented (at block 245; in this case, two (2) clusters). The electronic device 325 performs a second iteration of the iterative hierarchical clustering algorithm (at block 215) using the decremented number of clusters and assigns the sector carriers as follows:

| Cluster | Sector carriers |
|---|---|
| 1 | 0, 2, 3, 8, 9, 13, 16, 17, 18, 19 |
| 2 | 1, 6 |

Again, the number of sector carriers (10) that are initially to be assigned to Cluster 1 exceeds the maximum capacity of the cluster (8). The electronic device 325 selects (at block 230) a second set of sector carriers for Cluster 1, e.g., using a linear programming model or other suitable techniques. The two (2) additional sector carriers (Sector carriers 8, 18) are not selected. The electronic device 325 assigns (at block 235) the sector carriers as follows:

| Cluster | Sector carriers |
|---|---|
| 1 | 0, 2, 3, 9, 13, 16, 17, 19 |

The second set of sector carriers for Carrier 1 are removed (at block 240) so that these sector carriers are not subsequently assigned to another cluster. The distance matrix 355 is updated to remove the second set of sector carriers. The number of the plurality of clusters is decremented (at block 245; in this case, one (1) cluster). The electronic device 325 performs a third iteration of the iterative hierarchical clustering algorithm (at block 215) using the decremented number of clusters and assigns the remaining sector carriers as follows:

| Cluster | Sector carriers |
|---|---|
| 2 | 1, 6, 8, 18 |

Thus, according to the example sequence, the sector carriers are assigned as follows:

| Cluster | Sector carriers |
|---|---|
| 0 | 4, 5, 7, 10, 11, 12, 14, 15 |
| 1 | 0, 2, 3, 9, 13, 16, 17, 19 |
| 2 | 1, 6, 8, 18 |

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

1. A method performed by an electronic device for assigning computing resources, provided by a plurality of electronic devices of a mobile network, to support a plurality of sector carriers of the mobile network, the method comprising:
acquiring information describing the plurality of sector carriers that includes one or both of an affinity constraint and an anti-affinity constraint between different sector carriers of pairs of the plurality of sector carriers;
constructing, using the information describing the plurality of sector carriers, a distance matrix having values representing distances between different sector carriers of the plurality of sector carriers; and
applying, using the distance matrix and information describing the computing resources, an iterative hierarchical clustering algorithm to the plurality of sector carriers to assign the plurality of sector carriers among the plurality of electronic devices.

2. The method of claim 1,
wherein the anti-affinity constraint represents a resiliency requirement between the different sector carriers of the pairs, and
wherein the affinity constraint represents a mobility requirement between the different sector carriers of the pairs.

3. The method of claim 1, wherein constructing the distance matrix comprises:
assigning the values based on a presence of one or both of the affinity constraint and the anti-affinity constraint between the different sector carriers of the pairs of the plurality of sector carriers.

4. The method of claim 1, further comprising:
determining, using the information describing the computing resources, a minimum number of clusters to support the plurality of sector carriers, wherein each cluster corresponds to a respective electronic device of the plurality of electronic devices.

5. The method of claim 4, wherein determining the minimum number of clusters comprises one of:
receiving, as an input, a value for the minimum number of clusters; or
dividing a count of the plurality of sector carriers by a maximum capacity of a cluster of a plurality of clusters.

6. The method of claim 5, wherein applying the iterative hierarchical clustering algorithm comprises, in a first instance:
selecting a first set of sector carriers of the plurality of sector carriers to be assigned to a first cluster of the plurality of clusters; and
assigning, responsive to determining that the first set of sector carriers exceeds the maximum capacity of the first cluster, a second set of sector carriers to the first cluster, wherein sector carriers of the second set selected from the first set to meet the maximum capacity.

7. The method of claim 6, further comprising:
selecting the second set of sector carriers using a linear programming model.

8. The method of claim 1, further comprising:
calculating a penalty score associated with an assignment of the plurality of sector carriers among the plurality of electronic devices; and
when the penalty score is less than a previous penalty score associated with a previous assignment of the plurality of sector carriers among the plurality of electronic devices, reapplying the iterative hierarchical clustering algorithm with an increased minimum number of clusters.

9. The method of claim 8,
wherein a first affinity constraint has a first penalty term that is applied when the different sector carriers of the pairs are assigned to different electronic devices, and
wherein a second affinity constraint has a second penalty term that is applied when the different sector carriers of the pairs are assigned to different virtualization units on a same electronic device.

10. A non-transitory machine-readable storage medium comprising computer program code which, when executed by a computer performs operations for assigning computing resources, provided by a plurality of electronic devices of a mobile network, to support a plurality of sector carriers of the mobile network comprising:
acquiring information describing the plurality of sector carriers that includes one or both of an affinity constraint and an anti-affinity constraint between different sector carriers of pairs of the plurality of sector carriers;
constructing, using the information describing the plurality of sector carriers, a distance matrix having values representing distances between different sector carriers of the plurality of sector carriers; and
applying, using the distance matrix and information describing the computing resources, an iterative hierarchical clustering algorithm to the plurality of sector carriers to assign the plurality of sector carriers among the plurality of electronic devices.

11. An electronic device comprising:
a machine-readable medium comprising computer program code; and
one or more processors to execute the computer program code to perform operations for assigning computing resources, provided by a plurality of electronic devices of a mobile network, to support a plurality of sector carriers of the mobile network to:
acquire information describing the plurality of sector carriers that includes one or both of an affinity constraint and an anti-affinity constraint between different sector carriers of pairs of the plurality of sector carriers;
construct, using the information describing the plurality of sector carriers, a distance matrix having values representing distances between different sector carriers of the plurality of sector carriers; and
apply, using the distance matrix and information describing the computing resources, an iterative hierarchical clustering algorithm to the plurality of sector carriers to assign the plurality of sector carriers among the plurality of electronic devices.

12. The electronic device of claim 11,
wherein the anti-affinity constraint represents a resiliency requirement between the different sector carriers of the pairs, and
wherein the affinity constraint represents a mobility requirement between the different sector carriers of the pairs.

13. The electronic device of claim 11, wherein to construct the distance matrix further comprises operations to:
assign the values based on a presence of one or both of the affinity constraint and the anti-affinity constraint between the different sector carriers of the pairs of the plurality of sector carriers.

14. The electronic device of claim 11, wherein the operations further to:
determine, using the information describing the computing resources, a minimum number of clusters to support the plurality of sector carriers, wherein each cluster corresponds to a respective electronic device of the plurality of electronic devices.

15. The electronic device of claim 14, wherein to determine the minimum number of clusters comprises one of:
receive, as an input, a value for the minimum number of clusters; or
divide a count of the plurality of sector carriers by a maximum capacity of a cluster of a plurality of clusters.

16. The electronic device of claim 15, wherein to apply the iterative hierarchical clustering algorithm comprises, in a first instance, operations to:
select a first set of sector carriers of the plurality of sector carriers to be assigned to a first cluster of the plurality of clusters; and
assign, responsive to determining that the first set of sector carriers exceeds the maximum capacity of the first cluster, a second set of sector carriers to the first cluster, wherein sector carriers of the second set selected from the first set to meet the maximum capacity.

17. The electronic device of claim 16, wherein the operations further to:
select the second set of sector carriers using a linear programming model.

18. The electronic device of claim 11, wherein the operations further to:
calculate a penalty score associated with an assignment of the plurality of sector carriers among the plurality of electronic devices; and
when the penalty score is less than a previous penalty score associated with a previous assignment of the plurality of sector carriers among the plurality of electronic devices, reapply the iterative hierarchical clustering algorithm with an increased minimum number of clusters.

19. The electronic device of claim 18,
wherein a first affinity constraint has a first penalty term that is applied when the different sector carriers of the pairs are assigned to different electronic devices, and
wherein a second affinity constraint has a second penalty term that is applied when the different sector carriers of the pairs are assigned to different virtualization units on a same electronic device.

20. The non-transitory machine-readable storage medium of claim 10,
wherein the anti-affinity constraint represents a resiliency requirement between the different sector carriers of the pairs, and
wherein the affinity constraint represents a mobility requirement between the different sector carriers of the pairs.
